(19) United States
(12) Patent Application Publication
(10) Pub. No.: US 2017/0185761 A1
(43) Pub. Date: Jun. 29, 2017

(54) SYSTEM AND METHOD FOR BIOMETRIC KEY MANAGEMENT

(71) Applicant: Wi-LAN Labs, Inc., Carlsbad, CA (US)

(72) Inventors: Kenneth L. STANWOOD, San Diego, CA (US); David GELL, San Diego, CA (US); Erik COLBAN, San Diego, CA (US); Ronald MURIAS, Calgary (CA)

(21) Appl. No.: 15/300,222

(22) PCT Filed: Mar. 31, 2015
(86) PCT No.: PCT/US15/23514

§ 371 Date: Sep. 28, 2016

Related U.S. Application Data
(60) Provisional application No. 61/972,611, filed on Mar. 31, 2014.
(60) Provisional application No. 61/990,667, filed on May 8, 2014.

(51) Int. Cl. G06F 21/32; G06K 9/00; H04L 9/32; H04L 29/06; H04L 9/08

(52) U.S. Cl. CPC G06F 21/32; H04L 63/0428; H04L 63/10; H04L 9/0861; H04L 9/3231; G06K 9/00087; H03M 13/1515

(57) ABSTRACT

A biometric security server and a secure device are provided. A user is enrolled with the security server by collecting a biometric sample of the user and transforming the biometric sample to create and store a transformed enrollment biometric. A request to exchange information encrypted based on a biometric sample of the user is received from the secure device and a secure sketch output is generated from the transformed enrollment biometric and transmitted to the secure device. The secure sketch output has a measurement difference encoding portion and an error correction encoding portion. The secure device collects a local biometric sample and decodes the local biometric sample using the received secure sketch output. An amount of corrected errors associated with the decoded local biometric sample is determined. If the amount of corrected errors is less than a first pre-determined threshold a positive match is confirmed.

### RELATED APPLICATIONS

This patent application claims priority from U.S. Provisional Patent Application No. 61/972,611, filed Mar. 31, 2014, entitled “Biometric Key Management,” and from U.S. Provisional Patent Application No. 61/990,667, filed May 8, 2014, entitled “Fuzzy Extractor Use Cases in Biometric Key Management,” the entirety of both of which is incorporated herein by reference.

### BACKGROUND OF THE INVENTION

Field of Invention

The present invention relates to biometric authentication and more particularly to a system and method for providing enhanced biometric security for accessing a secure device and securing messages.

Description of the Related Art

There is a class of devices, such as safes, access control for doors and more recently, mobile devices, for which it is desirable to use biometrics for access or identity verification. Biometrics have the advantage that a person cannot forget them because such biometrics are an integral part of the person. However, there is a need to overcome numerous challenges when using biometrics for truly secure access to a secure device.

A stored copy of a biometric may create additional security vulnerability. Yet, at the same time, it is undesirable for an enrolled copy of the biometric, against which to authenticate, to be readily available to intercept and reuse when being provided to the secure device because this could decrease security. To avoid hacking of the secure device, the device may be “unconnected” from any network. That is to say, the secure device may not have persistent connectivity to the Internet, an enterprise intranet, or other network through which the device could be remotely accessed.

It is desirable for a biometric authentication system to ensure that false positives are below an acceptable threshold and to be resilient to presentation of fake or copied biometric samples. Biometrics are typically difficult to repeat with the bitwise exactness that is normally desired for security applications. This repeatability is particularly important if, in addition to access, the biometric acts as an encryption key to decrypt additional information, such as an associated level of access.

Two factor authentication and multifactor authentication are considered more secure than single factor authentication. Two factor authentication uses a factor from two of the categories:

1. Something the user has (e.g., ATM card, identifiable device),

2. Something the user knows (e.g., PIN, password),

3. Something the user is (e.g., fingerprint, iris pattern).

Multifactor authentication uses at least one factor from each category.

It is desirable to provide a system that overcomes the above described challenges and provides secure access to a secure device using biometrics as part of a two factor or multifactor verification of the identity of the user requesting access. It is additionally desirable to use a biometric to decrypt information associated with the user access of the secure device.

### BRIEF SUMMARY OF THE INVENTION

Embodiments of the present invention address deficiencies of the art in respect to biometric key management and provide a novel and non-obvious biometrics security system for operating a biometric security server to exchange encrypted information with a secure device. In accordance with one aspect of the present invention, a user is enrolled with the biometrics server, by collecting at least one biometric sample of the user, transforming the biometric sample to create a transformed enrollment biometric using a one way function, and storing the transformed enrollment biometric. The biometric server receives, from the secure device, a request to exchange information encrypted based on at least one biometric sample of the user. A secure sketch output is generated from the transformed enrollment biometric. The secure sketch output comprises a measurement difference encoding portion and an error correction encoding portion. The secure sketch output is transmitted to the secure device.

In accordance with another aspect of the invention, a method of verifying a biometric identifier is provided. A secure sketch output, derived from an enrollment biometric sample, is received from a biometric security server. At least one local biometric sample is collected and processed by transforming the at least one biometric sample to create a transformed biometric using a one way function, decoding the transformed biometric to resolve measurement differences with a measurement difference resolution decoder using the secure sketch output to create at least one decoded local biometric sample, correcting errors in the at least one decoded local biometric sample using an error correction code decoder to determine a number of corrected errors and create an estimated local biometric sample, and if the number of corrected errors is less than a first pre-determined threshold below which a positive match of the local biometric sample with the enrollment biometric sample is highly likely, confirming a positive match.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram of an example end-to-end system for providing access to a secure device in accordance with an example of the present invention;

FIG. 2 is a functional block diagram of a mobile device which may perform user identity verification and interact with a secure device via short range communication according to an example of the present invention;

FIG. 3 is a functional block diagram of an example biometrically secure device;

FIG. 4 is a functional block diagram of an example biometric security server;

FIG. 5 is a fingerprint sample segmented to provide a 640 sample fingercode example;

FIG. 6 is an example block diagram of a secure sketch module in accordance with one embodiment of the present invention;

FIG. 7 is an example block diagram of a secure sketch recovery module in accordance with one embodiment of the present invention;

FIG. 8 is an alternate example block diagram of a secure sketch module in accordance with another embodiment of the present invention;

FIG. 9 is an alternate example block diagram of a secure sketch recovery module in accordance with another embodiment of the present invention;

FIG. 10 is an example block diagram of a fuzzy extractor helper string generator module in accordance with one embodiment of the present invention;

FIG. 11 is an alternate example block diagram of a fuzzy extractor helper string generator module in accordance with another embodiment of the present invention;

FIG. 12 is an example block diagram of a fuzzy extractor reproduction module in accordance with one embodiment of the present invention;

FIG. 13 is a flowchart illustrating an example method for a biometric enrollment process with a biometric security server in accordance with one embodiment of the present invention;

FIG. 14 is a flowchart illustrating an example method for improving the confidence of a biometric identification in accordance with one embodiment of the present invention;

FIG. 15 is an event flow diagram illustrating events and interactions between a biometric security server and a user terminal when the user terminal is the biometrically secured device in accordance with one embodiment of the present invention;

FIG. 16 is a flowchart illustrating an example method of biometric identification of a biometrically secured user terminal performed by a security server in accordance with the event flow diagram of FIG. 15;

FIG. 17 is a flowchart illustrating an example method of biometric identification performed by a biometrically secured user terminal in accordance with the event flow diagram of FIG. 15;

FIG. 18 is an event flow diagram illustrating events and interactions between a biometric security server, a user terminal and a separate biometrically secured device in accordance with another embodiment of the present invention;

FIG. 19 is a flowchart illustrating an example method of biometric identification of a biometrically secured device user terminal performed by a security server via an intermediary user terminal in accordance with the event flow diagram of FIG. 18;

FIG. 20 is a flowchart illustrating an example method of biometric identification for a biometrically secured device performed by an intermediary user terminal in accordance with the event flow diagram of FIG. 18;

FIG. 21 is a flowchart illustrating an example method of biometric identification performed by a biometrically secured device via an intermediary user terminal in accordance with the event flow diagram of FIG. 18;

FIG. 22 is an example usage scenario which uses biometrics to authorize and encrypt transactions in an internet/mobile banking scenario wherein the user initiates a transaction via a mobile device or point of sale terminal;

FIG. 23 is an example usage scenario which uses biometrics to authorize and encrypt transactions in an internet/mobile banking scenario wherein the user is verified directly with a payment authority using a point of sale terminal or a user device;

FIG. 24 is an example usage scenario which uses biometrics to authorize and encrypt transactions in an internet/mobile banking scenario wherein the user is verified directly with a payment authority using a point of sale terminal and a user device;

FIG. 25 is an example usage scenario which uses biometrics to interact with a banking server; and

FIG. 26 is an example usage scenario which combines aspects of FIG. 22 and FIG. 25.

### DETAILED DESCRIPTION OF THE INVENTION

Embodiments of the invention provide for a biometric system, a biometric security server, a user terminal, a secure device, and methods for operating a biometric security server to exchange encrypted information with a secure device. The encrypted information may be used to provide access to the secure device or to decrypt messages received from the biometric security server. Features of the present disclosure include:
1. Using a private time base for a one-time key.
2. A secure sketch for biometrics using a measurement difference resolution code and an optional error correction code.
3. Creating a one-time use secure sketch (including recovery function) or one-time pad of secure sketches, optionally using a private time base that allows skipping of secure sketches.
4. A fuzzy extractor (both generator portion and reproduction portion) incorporating either one or both of a private time base and a one-time use secure sketch.
5. A system comprising a secure device (e.g., a biometrically secured user terminal or a separate secure device and intermediary user terminal) and a security server that allows a user to gain biometric-based access to the secure device without storing the user's biometric template on the secure device or transferring an actual biometric template to the secure device.
   a) Optionally using a private time base for a one-time biometric key used to decrypt a message accompanying the access.
   b) Optionally using a one-time secure sketch as a component of the biometric access.
      i) Optionally using a private time base that allows skipping of secure sketches.
6. A secure device and method for operating the secure device.
7. An enabled user terminal (i.e. smartphone) and method for operating the user terminal.
8. A security server and method for operating the security server.
9. An improved quality enrollment process.
10. A method of transforming fingerprint samples into fingercodes.
11. A method for increasing confidence in the biometric sample identification.
12. Use cases for the methods, systems and devices discussed herein.

As used herein, the terms “mobile device,” “wireless device,” “smartphone,” “user terminal” and “user equipment” may be used interchangeably.

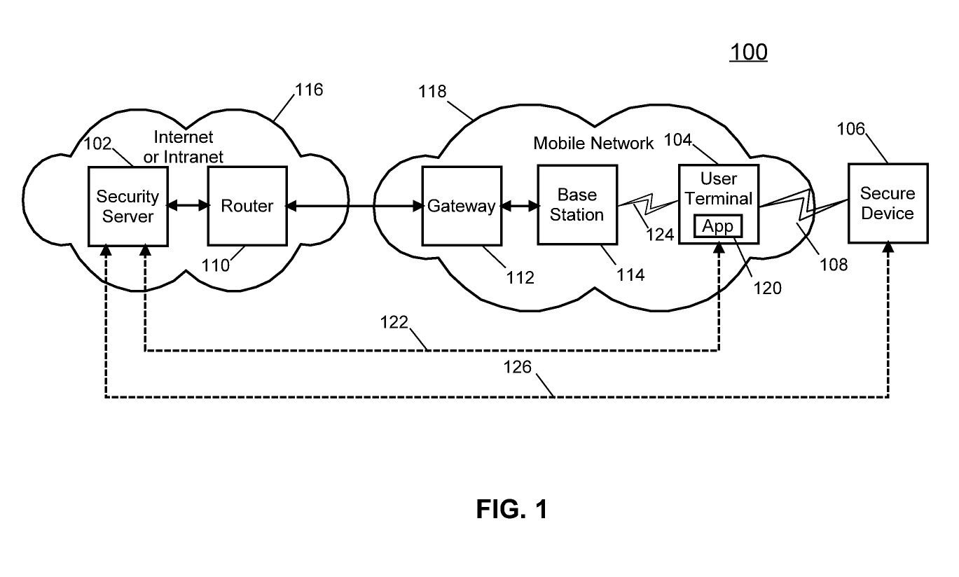

Turning now to FIG. 1, a block diagram of an example end-to-end system 100 for providing access to a biometrically secured device, wherein the system 100 may comprise a security server 102, a user terminal 104 (e.g., a smartphone), a separate secured device 106 (e.g., a safe, access door, key fob, etc.) plus enabling support devices. In some embodiments, the user terminal 104 itself may be biometrically secured. In other embodiments, the user terminal 104 acts as an intermediary device to transmit information between the separate secured device 106 and the security server 102.

Secure device 106 is generally unconnected. Secure device 106 can be temporarily connected with user terminal 104 via short range communication channel 108. Short range communication channel 108 may be created merely by sufficiently close proximity of user terminal 104 (i.e. inches for Near-Field Communications (NFC)) or may be temporarily enabled by, for instance, pressing a button or the like on the user interface of secure device 106.

Secure device 106 knows nothing about the user (i.e. secure device 106 stores no biometrics templates or other information about the user). But, secure device 106 receives fuzzy extractor generator output sufficient to compare to a locally sampled biometric of the user from the security server 102 via user terminal 104 and all intervening or supporting devices (e.g., router 110, gateway 112, base station 114) and networks (e.g., Internet or Intranet 116 and mobile network 118).

User terminal 104 has an application 120 (i.e. “app”) with a logical connection 122 to security server 102. User terminal 104's proximity to secure device 106 allowing connectivity over short range communication channel 108 or a wired connection (not shown), combined with user terminal 104's connectivity to base station 114 via communication channel 124 allows user terminal 104 to exchange information between secure device 106 and security server 102 over logical connection 126 without persistent physical connections.

Router 110 and gateway 112 are examples. There could be more or fewer. There could be switches, etc. These devices merely complete the connectivity, but otherwise are not noteworthy for the inventions.

In one aspect, security server 102 first verifies the user of user terminal 104, via methods known to one skilled in the art. Subsequently, security server 102 passes information, i.e. fuzzy extractor generator function output, sufficient for a local biometric verification of the user to secure device 106 via user terminal 104 in a form that:

A. Cannot be intercepted and altered to verify a different user
B. Does not disclose the identity of the user
C. Cannot be used again by the user, in case the user's access rights are revoked.
D. Does not require constant, reliable time synchronization between the security server 102 and the secure device 110.
E. Allows secure transport and decryption of a related message.

The use of a secure sketch in a fuzzy extractor achieves (B) and achieves (A) with the caveat that current art is concerned that secure sketches may be able to be reverse engineered if enough usage data is intercepted. The use of one time keys (or pads) in the hash functions of the fuzzy extractor achieves C. The use of a one-time secure sketch strengthens the accomplishment of C and A. The use of a private time base with shared secret internal parameters for the one-time keys and one-time secure sketch achieves D. The use of a robust fuzzy extractor with two hash functions, one for verification and a second for encryption/decryption achieves E.

Herein, the term “hash function” means “cryptographic hash function.” Cryptographic hash functions are differentiated from other hash functions in that they have the properties that:
1) It is practically infeasible to generate a message from its hash value.
2) It is infeasible to modify a message without changing its hash value.
3) It is infeasible to find two different messages with the same hash value.

Any one-way function that meets these criteria may replace any of the hash functions used herein.

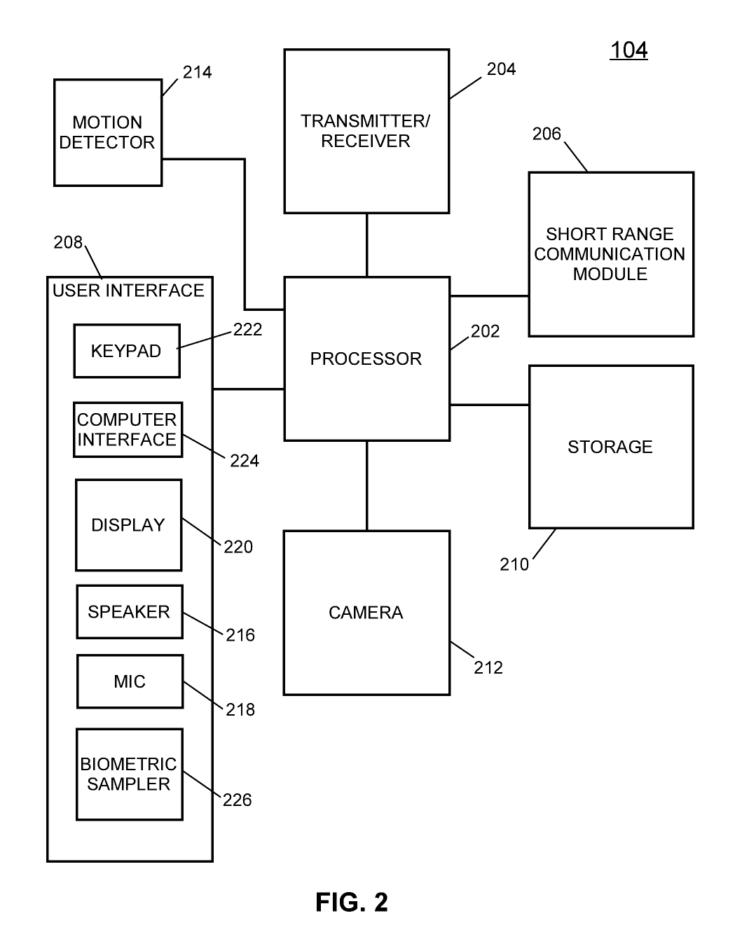

FIG. 2 is a functional block diagram of a mobile device (i.e. user terminal 104) which may perform user identity verification. Additionally, user terminal 104 may interact with a secure device 106 via short range communication according to an example embodiment. In various example embodiments, the user terminal 104 may be, for example, but not limited to, a smartphone, a laptop or computer with an integrated or attached camera, or the like. The user terminal 104 includes a processor 202. The processor 202 is communicatively coupled to a transmitter/receiver (transceiver) 204, short range communication module 206, a user interface 208, a storage 210 (i.e. memory), a camera 212 and a motion detector 214. The processor 202 may be a single processor, multiple processors, or a combination of one or more processors and additional logic such as application-specific integrated circuits (ASIC) or field programmable gate arrays (FPGA).

The transmitter/receiver 204 may be configured to transmit and receive communications with other devices. For example, the transmitter/receiver 204 may communicate with a cellular or broadband base station such as an LTE evolved node B (eNodeB) or WiFi access point (AP). Mobile device 104 may generally include one or more antennae for transmission and reception of radio signals.

Although the user terminal 104 of FIG. 2 is shown with a single transmitter/receiver 204, other example embodiments of the mobile device 104 may include multiple transmitter/receivers. The multiple transmitter/receivers may operate according to different protocols, for instance, separate cellular and WiFi transmitter/receivers.

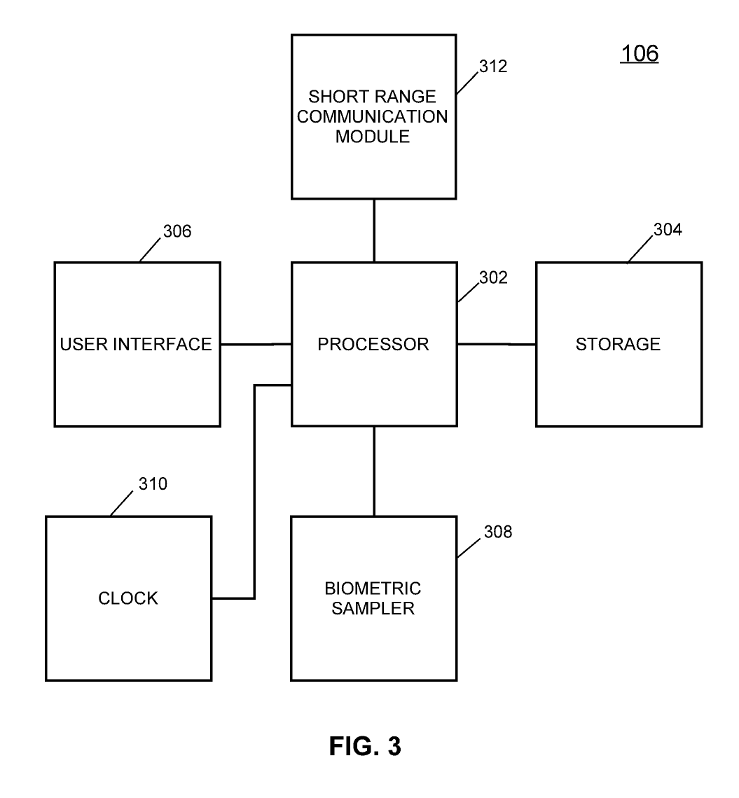

The short range communications module 206 may be configured to transmit and receive communications with other nearby devices. For example, the short range communications module 206 may communicate with the secure device 106 such as depicted in FIG. 3 using Near Field Communications (NFC) or Bluetooth Low Energy (BLE) technology. Communications using short range communication module 206 may be encrypted.

The mobile device 104, in some example embodiments, may provide data to and receive data from a person (user). Accordingly, the mobile device 104 may include a user interface 208. The user interface 208 may include modules for communicating with a person. The user interface 208, in an example embodiment, may include a speaker 216 and a microphone 218 for voice communications with the user, a display 220 for providing visual information to the user, and a keypad 222 for accepting alphanumeric commands and data from the user. In some example embodiments, the display 220 may include a touch screen which may be used in place of or in combination with the keypad 222. The touch screen may allow graphical selection of inputs in addition to alphanumeric inputs.

In an alternative example embodiment, the user interface 208 may include a computer interface 224, for example, but not limited to, a universal serial bus (USB) interface, to interface the user terminal 104 to a computer. For example, the user terminal 104 may be in the form of a dongle that can be connected to a notebook computer via the user interface 208. The combination of computer and dongle may also be considered a user terminal 104. The user interface 208 may have other configurations and include functions such as vibrators, LEDs and lights.

The processor 202 may process communications received and transmitted by the mobile device 104. The processor 202 may also process inputs from and outputs to the user interface 208 and the camera 212. The storage 210 may store data for use by the processor 202, including images or metrics derived from images. The storage 210 may also be used to store computer readable instructions for execution by the processor 202. The computer readable instructions can be used by the mobile device 104 for accomplishing the various functions of the mobile device 104.

The storage 210 may also be used to store photos, such as those taken by camera 212. In an example embodiment, the storage 210 or parts of the storage 210 may be considered a non-transitory machine-readable medium. In an example embodiment, storage 210 may include a subscriber identity module (SIM) or machine identity module (MIM).

For concise explanation, the mobile device 104 or example embodiments of the mobile device 104 are described as having certain functionality. It will be appreciated that in some example embodiments, this functionality is accomplished by the processor 202 in conjunction with the storage 210, the transmitter/receiver 204, the camera 212, the user interface 208 and the motion detector 214. Furthermore, in addition to executing instructions, the processor 202 may include specific purpose hardware to accomplish some functions.

In one embodiment, user interface 208 includes a biometric sampler 226. Biometric sampler 226 may provide a means of taking a local biometric sample. In an embodiment, biometric sampler 226 is a fingerprint scanner. In an alternate embodiment, biometric sampler 226 may be camera 212 equipped to take a photo adequate for facial recognition or for iris recognition. Biometric sampler 226 may incorporate methods for sampling more than one biometric.

The camera 212 may capture video and still photos as is common with a digital camera. The camera 212 may display the video and still photos on the display 220. The user interface 208 may include a button which can be pushed to cause the camera 212 to take a photo. Alternatively, if the display 220 comprises a touch screen, the button may be a touch sensitive area of the touch screen of the display 220.

The camera 212 may pass video or photos to the processor 202 for forwarding to the user interface 208 and display on the display 220. Alternatively, the camera 212 may pass video or photos directly to the user interface 208 for display on the display 220. The processor 202 may cause the user interface 208, including the display 220, to display an alignment aid. The processor 202 may implement a portion of facial recognition or iris recognition technology sufficient to determine when the camera image from the camera 212 is favorably aligned with the alignment aid. When the camera image from the camera 212 is favorably aligned with the alignment aid, the processor 202 may cause the camera 212 to take a photo.

The camera 212 may pass video or photos to the processor 202 for storage in the storage 210. The processor 202 may compare the photos or metrics derived from photos to photos or metrics stored in the storage 210 for the purpose of facial recognition or iris recognition. Alternatively, the processor 202 may pass photos from the camera 212 to another computer or device for remote application of facial recognition or iris recognition technology. The combination of a computer or mobile device and a device that performs remote application of facial recognition or iris recognition may also be considered a user terminal 104.

Some iris recognition technology works with visible light. Other iris recognition technology works with near infrared light. Having both technologies improves the reliability of iris detection technology. In an example embodiment, the camera 212 may operate using visible light to take photos. In an example embodiment, the camera 212 may be capable of taking photos using near infrared light. Some standard digital cameras have the ability for detection of near infrared light, but at a quality less than that of a camera designed for near infrared light. For these cameras, illuminating the subject with near infrared light enhances the camera's ability to take a photo in the near infrared spectrum.

In an example embodiment, the mobile device 104 may have a near infrared light source, such as an led or other light or built into the display 220, which the processor 202 can cause to illuminate the subject to enhance a photo taken by the camera 212. In an alternate example embodiment, an external near infrared light source may be attached to the mobile device 104 to achieve the same effect. In example embodiments where near infrared photos are possible, the mobile device 104 may acquire photos using visible light, near infrared light, or both for use in iris recognition.

Motion detector 214 may be a known type of inertial motion detection device, such as one or more accelerometer, gyroscope, etc. In an aspect, motion detector 214 may detect motion of the mobile device 104 for use as an input to a user interface selection or to another functionality of mobile device 104.

Mobile device 104 may implement verification capability to verify that a user of mobile device 104 has appropriate access to the device. Known types of user verification functionality may be used. In an aspect, mobile device 104 may implement verification functionality such as that described in U.S. patent application Ser. No. 13/743,149, entitled “System and Method for Positive Identification on a Mobile Device,” which is incorporated herein by reference.

FIG. 3 is a functional block diagram of a secure device 106. Secure device 106 may be comprised of a processor 302 communicatively coupled to a storage (i.e. memory) 304, a user interface 306, a biometric sampler 308, a clock 310, and a short range communication module 312. Processor 302 executes instructions to implement aspects of the invention. In an aspect, processor 302 executes instructions to perform security operations, such as the reproduction function of a fuzzy extractor or the decrypting of messages, using inputs from the other components. The processor 302 may be a single processor, multiple processors, or a combination of one or more processors and additional logic such as one or more application□specific integrated circuit (ASIC) and/or field programmable gate array (FPGA).

Short range communication module 312 may provide close proximity wireless connectivity allowing the transfer of data to a sufficiently close and similarly enabled device such as user terminal 104 (e.g., a smartphone). Short range communication module 312 may use any of a variety of suitable technologies, such as NFC, BLE or a wired connection, for example. Short range communication module 312 may, for instance, transfer information such as a device ID from storage 304 to an external device such as user terminal 104. Short range communication module 312 may accept information, such as an access request and accompanying user identity information, from an external device. Communications using short range communication module 312 may be encrypted.

Storage 304 may be a memory device such as a RAM, ROM, EEPROM, hard disk, or known type of solid state memory device. Storage 304 may store data for use by the processor 302. Storage 304 may also be used to store computer readable instructions for execution by the processor 302. The computer readable instructions may implement various functions as described in the embodiments set forth herein. In an embodiment, storage 304, or parts of the storage 304, may be considered a non-transitory machine readable medium. Storage 304 may, for instance, include non-volatile, long term secure storage for a secure device ID and shared secrets, such as, keys, one-time pads, secure sketch parameters, sets of secure sketch outputs, and time base parameters. Storage 304 may include one or more tamper-resistant devices and may be protected against unauthorized access and usage. Storage 304 may, for instance, provide short term storage for local biometrics, encrypted and plain text version of messages, and fuzzy extractor generator and reproduction function outputs.

Biometric sampler 308 may provide a means of taking a local biometric sample. In an embodiment, biometric sampler 308 is a fingerprint scanner. In an alternate embodiment, biometric sampler 308 may be a camera equipped to take a photo adequate for facial recognition or for iris recognition. Biometric sampler 308 may incorporate methods for sampling more than one biometric.

Clock 310 may provide a means for keeping time. In an embodiment, the current time may be reset based on an input received, for instance, via short range communication module 312.

User interface 306 may provide a means of granting access to a verified user of secure device 106. For instance, user interface 306 may include a handle for a safe drawer or for a door and the latches necessary to secure the drawer or handle. User interface 306 may include buttons, a keypad, or a touch screen for allowing the user to initiate communications between short range communication module 312 and user terminal 104. User interface 306 may include buttons, a keypad, or a touch screen for allowing the user to initiate a local biometric collection by biometric sampler 308. User interface 306 may include lights or a display to provide feedback to the user such as passed or failed verification, successful or unsuccessful local biometric collection, or information from a message decrypted by processor 302. In an embodiment, user interface 306 may also be used as an input device for passwords, PINs or other information used for 2-factor or multifactor authentication.

It will be appreciated that processor 302 is in communication and cooperates with storage 304, short range communication module 312, user interface 306, biometric sampler 308, and clock 310 to implement various aspects of the invention as described herein. Furthermore, in addition to executing instructions, processor 302 may include specific purpose hardware to accomplish some functions. One skilled in the art would understand that in some embodiments, user device 104 and secure device 106 are incorporated into the same device. In this case, short range communication module 206 and short range communication module 312 are optional.

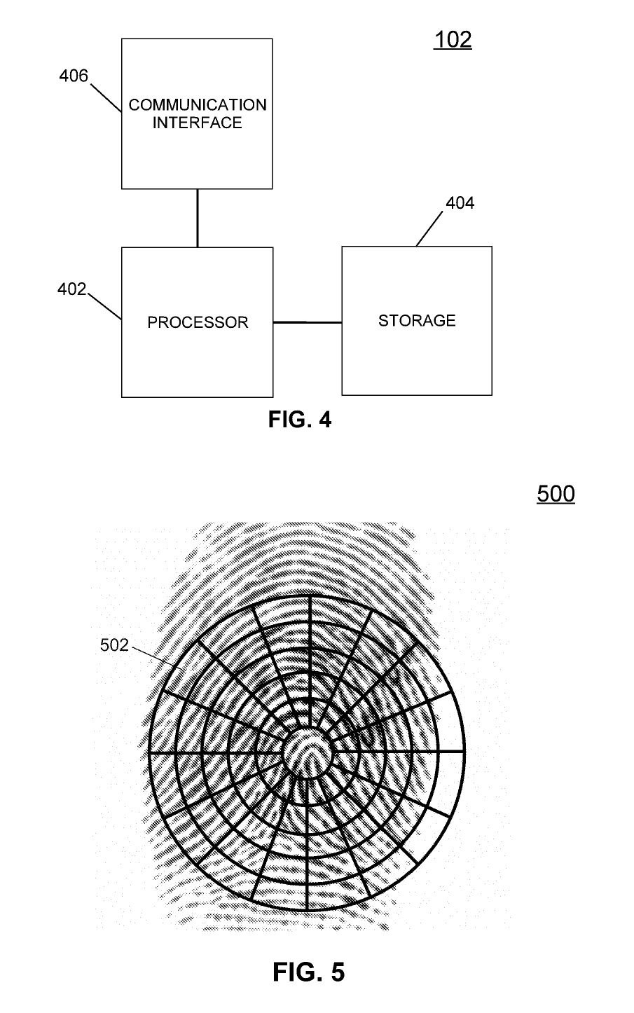

FIG. 4 is a functional block diagram of a biometric security server 102. Security server 102 may be comprised of processor module 402 communicatively coupled to storage 404 (i.e. memory) and communication interface module 406. The processor 402 may be a single processor, multiple processors, or a combination of one or more processors and additional logic such as application-specific integrated circuits (ASIC) or field programmable gate arrays (FPGA).

Storage 404 may be a memory device such as a RAM, ROM, EEPROM, hard disk, or known type of solid state memory device. Storage 404 may store data for use by the processor 402. Storage 404 may also be used to store computer readable instructions for execution by the processor 402. The computer readable instructions may implement various functions as described in the embodiments set forth herein. In an embodiment, storage 404, or parts of the storage 404, may be considered a non-transitory machine readable medium. Storage 404 may, for instance, include long term, non-volatile, secure storage for secure sketches, biometric templates, user access rights, and shared secrets, such as, keys, one-time pads, secure sketch parameters, sets of secure sketch outputs, and time base parameters. Storage 404 may, for instance, provide short term storage for fuzzy extractor generator function outputs and user verification results.

Communication interface module 406 is an interface for providing communication with another device, such as router 110, enabling the security server 102 to communicate with applications on a user's device, such as user terminal 104. Communication interface module 406 may, for instance, provide a high speed Gigabit Ethernet (GigE) interface.

It will be appreciated that processor 402 is in communication and cooperates with storage 404 and communication interface module 406 to implement various aspects of the invention as described herein. Furthermore, in addition to executing instructions, processor 402 may include specific purpose hardware to accomplish some functions. For example, in an aspect, processor 402 may execute instructions to implement fuzzy extractor Gen functionality, encryption functionality, and/or initial phone-based biometric verification functionality as described herein.

One-Time Key with Private Time Base

As described above, it may be desirable to have the information against which the local biometric sample of the user is verified by the secure device (e.g., user terminal 104, secure device 106) be useable once or only in a small time window. One-time keys and one-time pads help achieve this goal. For instance, IETF RFC 4226 defines the HMAC-based One-Time Password (HOTP) which uses a hash function HOTP( ) a shared secret K, and a counter C. A key or password is generated as Key=HOTP(K,C). The counter continues counting upwards, never to repeat.

It may be desirable to have a window larger than a counter tick during which a key is valid. IETF RFC 6238 defines the Time-Based One-Time Password (TOTP) which is a variant of HOTP where the counter C is replaced with T which is a function of time. The one-time password or key is generated as Key=TOTP(K,T). T is defined as T=[(Current UNIX Time−T₀)/X]. T₀ is an offset to a “start time” for the generation of T. X is a time window, for instance, 30 seconds. X is chosen to provide a validity time window during which the key or password may be used. Due to possible lack of synchronization between the two endpoints, e.g., the secure device 106 and security server 102 of FIG. 1, of a secure transaction generating T, it is common to also generate Key2=TOTP(K,T−1) and Key3=TOTP(K,T+1). This effectively creates a window that is three times the duration of X.

HOTP and TOTP are both based on HMAC-SHA-1 with truncation. One skilled in the art would understand how to modify these or other hash functions to not use truncation or to truncate to a different number of bits.

These two examples of one-time key generation require the two endpoints of the secure exchange to be time synchronized. This may be problematic as clocks can drift relative to each other in a system such as shown in FIG. 1 where secure device 106 is isolated from other devices, in particular from the security server 102. Additionally, current time is known, and future time can be predicted from past time. This may increase the vulnerability of a system using one-time keys if an attacker has access to multiple outputs of the hash function at different known times.

To solve this, for a hash function that uses time as an input, we define a private time base. The private time base generates a private current time, Tₚ. Time T may be defined as a function F(Tₚ,T₀,X), for instance T=F(Tₚ,T₀,X)=[(Tₚ−T₀)/X]. In an embodiment where T is used to index into a one-time pad or list, T=F(Tₚ,T₀,X)=[(Tₚ−T₀)/X] modulo one-time pad length. In the private time base function, T₀ and X are shared secrets between the secure device 106 and the security server 102 in the same way as the hash function shared secret, K. Tₚ may be generated by the security server 102 at the time of use and passed to the secure device 106 along with data on which to apply the one-time key. The secure device may set its internal clock to time Tₚ, allowing “time” to progress from that point. Since T₀ and X are secret, the value of T generated from Tₚ will be difficult to guess within the window during which T is valid. In an embodiment, new values of Tₚ are later in time (e.g., greater value) than previously used values of Tₚ. A hash function Key=H(K,T) is used to generate the key. This use of a private time base mitigates any time synchronization issues, hides the value of T, allows a changing value of time to decrease predictability of future values of T, allows each secure device 106 to have a unique validity time window X, and eliminates the need to allow a user to attempt using T−1 or T+1. These benefits increase security over a known time base. In an embodiment, a private time base is used with a time-based one-time key function.

One skilled in the art would understand how a private time base could be used to generate a time T used for selecting a one-time use (i.e., discarded after use) shared secret K_{T} from a one-time pad of shared secrets and using Key=H(K_{T}) rather than Key=H(K,T) to generate a one-time key.

One skilled in the art would understand that additional information, A, may be used as input to a hash function, for instance by concatenating the input strings, denoted as Key=H(K,T,A).

Pseudo One-Time Use Secure Sketch with Private Time Base

It may be desirable to verify the identity of the user attempting to access a secure device (e.g., user terminal 104, secure device 106) by comparing a biometric, for instance a fingerprint or an iris scan, collected locally at the device 104, 106 with a biometric sample that has been previously collected and verified to be from the user, for instance stored at secure server 102. However, as stated above, the necessary exchanged information should have the properties that it:

A. Cannot be intercepted and altered to verify a different user.

B. Does not disclose the identity of the user.

C. Cannot be used again by the user, in case the user's access rights are revoked.

In an aspect, to accomplish these goals, a novel modification of a concept called a secure sketch is used. A secure sketch makes it possible to recover erroneous or noisy data. In the present invention, a secure sketch is used to resolve measurement differences between a local biometric sample taken at a secure device and an enrollment biometric sample without needing the enrollment biometric sample at the secure device. If the input to the secure sketch is “B” and the secure sketch output is “s,” then given s and a value B′ sufficiently close to B, one can reconstruct B from s and B′. However, the secure sketch output s should not provide sufficient information regarding B to reconstruct B without a sufficiently close input B′.

Many variants of a fingercode may be used for transforming a fingerprint into an alternative biometrics for input to a secure sketch. Referring to FIG. 5, for a six hundred forty (640) sample fingercode example, the fingerprint 500 was segmented into five (5) bands of sixteen (16) sectors each, giving eighty (80) cells 502.

In this example, a bank of eight Gabor filters, each at a different angle of orientation, was applied to each of the eighty cells. This may be used to compute, for instance, the average absolute deviation (AAD) from the mean of the responses of each filter over the pixels of the cell, giving six hundred forty (640) such values, eight for each cell. These AAD samples comprising the fingercode may be transformed to 8-bit values for convenient processing.

In an alternate embodiment (not shown), four bands of sixteen sectors each, resulting in sixty-four cells, may have eight Gabor filters applied resulting in a fingercode comprised of five hundred twelve (512) values. The angular width of the sectors may be chosen such that the pixels in the cells may overlap. Additionally, the width of the bands may also be chosen such that the pixels in the cells may overlap. The values may be computed with more or less resolution, for instance resulting in 9-bit values in the range 0-511 rather than 8-bit values in the range 0-255. One skilled in the art would understand that different resolutions of the values comprising the fingercode may result in more or fewer bits being required when a measurement difference resolution code is used to transform the fingercode into a measurement difference resolution code. One skilled in the art would also understand that different resolutions of the values comprising the fingercode would result in more or fewer bits being available as least significant bits when least significant bit extraction is used to transform the fingercode into a measurement difference resolution code.

In an embodiment, only a portion of the bits may be used to transform the fingercode into an error correcting code. For example, for a fingercode created with 9-bit resolution, the eight most significant bits may be used in a Reed-Solomon code to transform the fingercode into an error correcting code.

In an embodiment, the transformation of a fingerprint into a fingercode may include one or more of the following steps using techniques known to one skilled in the art:
Determining the core of the fingerprint
Preprocessing the fingerprint for clarity
Rotating the fingerprint
Rotating the Gabor filters as an alternative to rotating the fingerprint

One skilled in the art would understand that similar differences in number of samples, sample resolution, and preprocessing may be applied when transforming an iris biometric into an IrisCode.

Returning now to the secure sketch example, because s does not provide sufficient information to reconstruct B without a suitable B′, using a secure sketch for the biometric comparison has the advantage that the security server 102 need only store the secure sketch output s. This allows the original biometric sample B to not be stored which prevents B from being compromised, therefore, protecting the user's identity from compromise.

The secure sketch function, SS(B)=s, should be a one-way function with recovery function Rec(B′,s)=B for B′ sufficiently close to B. If local biometric sample B′ and the original biometric sample B are taken from the same user, they should vary based on the measurement uncertainty of the biometric sampling method. That is, differences may be viewed as measurement differences. When determining whether B′ is sufficiently close to B, the greater the correcting capability of the secure sketch function SS(B), the greater the immunity to measurement differences is (i.e., less likelihood of false negative). However, the greater the correcting capability of secure sketch function SS(B), the less secure due to the larger number of different local samples that could be “corrected” to match W (i.e., more likelihood of false positive) and the more information contained about the user's identity.

In communications systems, well-known Reed-Solomon codes are popular for correcting transmission errors in messages and may be used to correct measurement differences in biometric samples.

Reed-Solomon codes have the property that they correct burst errors on symbols, e.g., an 8-bit byte. That is to say, they correct a certain number of errored bytes whether those bytes each have 1 bit error or multiple bit errors. This property is useful for communications systems transmission errors caused by poor channel conditions and often occurring in bursts. While still useful for correcting differences in biometric samples, differences in biometric samples are measurement differences rather than transmission errors. For instance, rather than bursts of errored symbols and non-errored symbols as is common in transmission errors, two instances B and B′ of a biometric sample such as a FingerCode, from the same individual, could differ by a single measurement quantization level (e.g., measure a 7 versus an 8) for many or all of the 640 measurements (symbols) making up the biometric samples. Since a Reed-Solomon code would perform the same whether the two samples are barely different or grossly different, a Reed-Solomon code by itself would need to have strong correction relative to the data. This may convey greater amounts of information about the biometric B or may result in a larger number of false positives. Therefore, there is a need for resolution of many minor measurement differences prior to using a code such as a Reed-Solomon to resolve any remaining errors, for instance errors due to the blank cells 502 on the right hand side of FIG. 5 where insufficient pressure was applied by the user.

In an embodiment, a novel Hamming code is used for resolving measurement differences in parallel with an optional Reed-Solomon code for correction of a number of more gross errors (e.g., cut on finger) to provide a secure sketch that does not give enough information about input B without sufficiently close B′, yet is tolerant of the measurement differences seen in biometrics such as FingerCode and IrisCode.

While one skilled in the art would understand that other error correcting codes or concatenated error correcting codes (e.g., an inner and outer code) could be used instead of Reed-Solomon codes and Hamming Codes, the invention will be explained using the example of Reed-Solomon codes in combination with Hamming codes or with a code comprised of the least significant bits of the enrollment biometric.

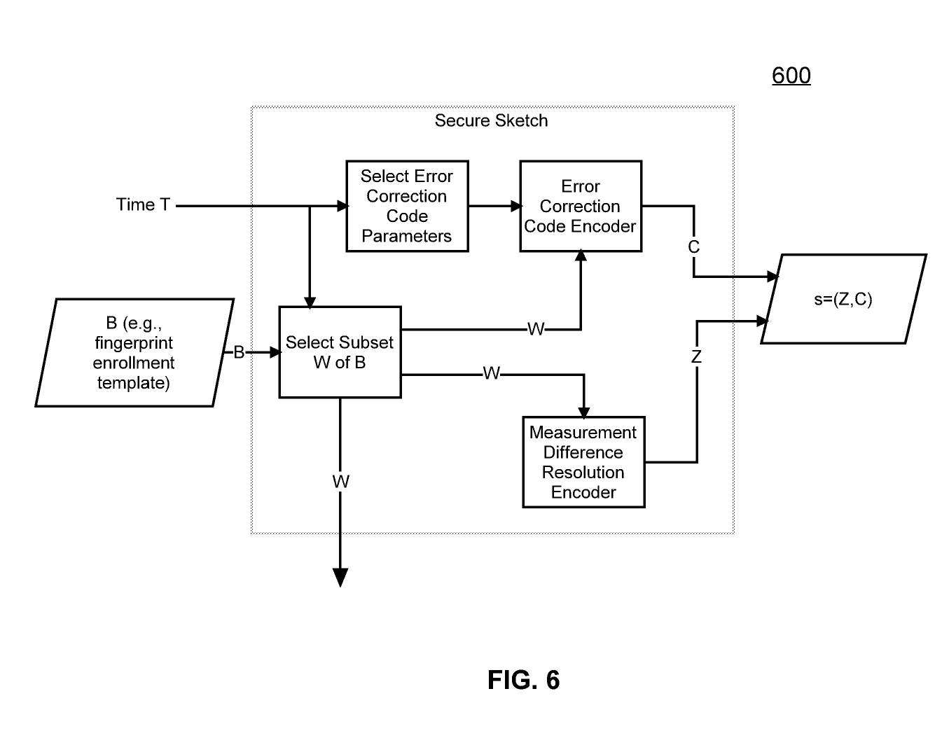

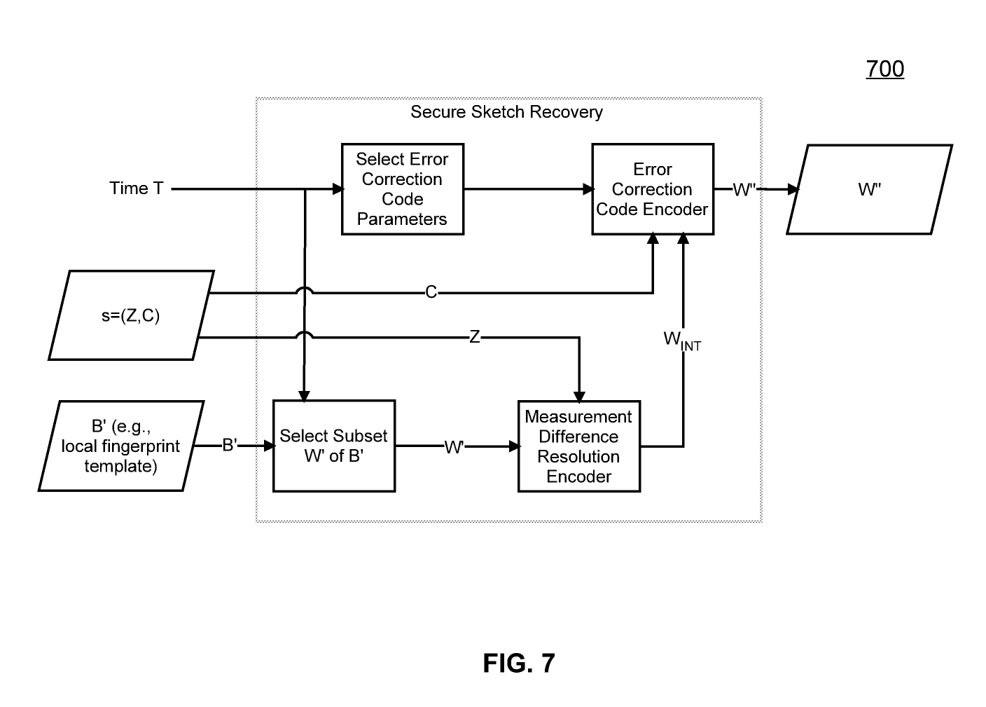

Block diagrams of example secure sketch and secure sketch recovery modules are shown in FIGS. 6 and 7. These figures show the use of time as an input to create a one-time or pseudo one-time secure sketch by selecting a subset of the biometric as input to the measurement resolution encoder and decoder (e.g., Hamming encoder and decoder) and/or modifying the parameters of the error correction code encoder and decoder (e.g., Reed-Solomon encoder and decoder) as a function of time.

Description of Measurement Difference Resolution Encoder/Decoder Embodiments

Measurement Difference Resolution Code Description

A (12,8) Hamming Code that can add 4 parity bits to an 8-bit data byte (e.g., 12 total bits with 8 bits of data) to enable correction of a single bit error in the 8-bit data byte can be generated by the following method and shown in Table 1 (adapted from the algorithm on Wikipedia, incorporated by reference).
1) Number the bit positions in binary (base 2) starting with 1 (e.g. 0001b, 0010b, 0100b, 1000b)
2) All bit positions that are powers of two are parity bits.
3) All other bit positions are data bits and are covered by a unique set of 2 or more parity bits
4) Parity bit n covers data bit positions as shown in the table below, based on the binary representation of their position (e.g., if the bit representing the parity bit position is set in the bits representing the data bit position).

TABLE 1

| | | Binary Bit Pos | | | | | | | | | | | |
|---|---|---|---|---|---|---|---|---|---|---|---|---|---|
| | | 0001 | 0010 | 0011 | 0100 | 0101 | 0110 | 0111 | 1000 | 1001 | 1010 | 1011 | 1100 |
| Bit ID | | p1 | p2 | d1 | p4 | d2 | d3 | d4 | p8 | d5 | d6 | d7 | d8 |
| Parity Bit | p1 | X | | X | | X | | X | | X | | X | |
| Coverage | p2 | | X | X | | | X | X | | | X | X | |
| | p4 | | | | X | X | X | X | | | | | X |
| | p8 | | | | | | | | X | X | X | X | X |

One skilled in the art would understand that the Hamming code can be extended to cover any number of data bits.

Measurement differences, expressed in standard binary base two notation have the property that two adjacent measurement values may differ by many bits rather than only one bit. For instance, the decimal value 7, represented as 8 binary bits (a byte), is 00000111b while the decimal value 8, represented as 8 binary bits, is 00001000b. These adjacent measurement values differ in 4 bits. However, the decimal value, 12 represented as 8 binary bits, is 00001100, which differs from the representation for the decimal value 8 in only a single bit.

To overcome the representation difference in two adjacent measurements, two alternative novel embodiments using the above Hamming code are described. The first embodiment uses the Hamming code as a maximum likelihood corrector to find the correct measurement value. The second embodiment changes the binary representation of the data away from the standard base 2 representation such that the representations of adjacent measurement values differ in at most one bit.

Let B(i) denote the ith measurement in biometric sample B. Let B′(i) denote the corresponding ith measurement in biometric sample B′. Let Z(i) denote the 4 parity bits of an (12,8) Hamming Code on B(i) with Z denoting the set of all Z(i) corresponding to B. The goal is to recreate B(i) given only Z(i) and B′(i) from B′ sufficiently close to B.

Z(i) does not contain sufficient information to recreate B(i) solely from Z(i). Each Z(i) can map to up to 16 different values for B(i). For a 640 byte or 512 byte FingerCode or a 256 byte IrisCode, this creates an impractically large number of possible combinations to guess.

In a first embodiment, rather than applying Z(i) to B′(i) to convert B′(i) into B(i), calculate Z′(i) denoting the 4 parity bits of an (12,8) Hamming Code on B′(i).

If Z′(i)=Z(i) then set W_{INT}(i)=B′(i).

If Z′(i) Z(i) then set W_{INT}(i)=the value closest to B′(i) that would generate (12,8) Hamming parity bits Z(i).

For instance, as shown Table 2 below, if B′(i)=113 (01110001b) then Z′(i)=0001b. However, if Z(i)=1110b, B(i) could equal 124, 111, 89, etc. The closest of these to 113 is 111, so set W_{INT}(i) to 111 since this has the highest likelihood if B and B′ are biometrics from the same person.

TABLE 2

| Measurement | 8-bit Binary | p1 | p2 | p4 | p8 |
|---|---|---|---|---|---|
| . . . | . . . | | | | |
| 108 | 01101100 | 0 | 0 | 0 | 0 |
| 109 | 01101101 | 0 | 0 | 1 | 1 |
| 110 | 01101110 | 1 | 1 | 0 | 1 |
| 111 | 01101111 | 1 | 1 | 1 | 0 |
| 112 | 01110000 | 0 | 0 | 1 | 0 |
| 113 | 01110001 | 0 | 0 | 0 | 1 |
| 114 | 01110010 | 1 | 1 | 1 | 1 |
| 115 | 01110011 | 1 | 1 | 0 | 0 |
| 116 | 01110100 | 0 | 1 | 1 | 1 |
| 117 | 01110101 | 0 | 1 | 0 | 0 |
| 118 | 01110110 | 1 | 0 | 1 | 0 |
| 119 | 01110111 | 1 | 0 | 0 | 1 |
| 120 | 01111000 | 1 | 0 | 1 | 1 |
| 121 | 01111001 | 1 | 0 | 0 | 0 |
| 122 | 01111010 | 0 | 1 | 1 | 0 |
| 123 | 01111011 | 0 | 1 | 0 | 1 |
| 124 | 01111100 | 1 | 1 | 1 | 0 |
| 125 | 01111101 | 1 | 1 | 0 | 1 |
| 126 | 01111110 | 0 | 0 | 1 | 1 |
| 127 | 01111111 | 0 | 0 | 0 | 0 |
| . . . | . . . | | | | |

W_{INT}(i) is the estimate of B(i) after using the Hamming code as a maximum likelihood corrector. In an embodiment, the difference between B′(i) and allowable values of W_{INT}(i) may be bounded. For example, in the above example, if the allowable deviation from B′(i) is +/−1 measurement, the only allowable values of W_{INT}(i) are 112, 113, and 114 when B′(i)=113. Since none of these have parity bits matching Z(i), W_{INT}(i) would be set to B′(i) and a subsequent Reed-Solomon or other error correction would be relied upon to correct some number of erroneous W_{INT}(i). This allows a fine tuning of the tradeoff between false detection and false rejection.

In another embodiment, rather than representing the measurements B(i) and B′(i) in standard base 2 binary representation and then calculating parity bits, B(i) and B′(i) are represented in a binary notation where adjacent measurement values to differ by at most a single bit.

For instance, the Table 3 represents the decimal numbers 0 to 15 as 4-bit nibbles in a binary representation where adjacent measurement values to differ by at most a single bit.

TABLE 3

| Measurement | binary |
|---|---|
| 0 | 0000 |
| 1 | 0001 |
| 2 | 0011 |
| 3 | 0010 |
| 4 | 0110 |
| 5 | 0111 |
| 6 | 0101 |
| 7 | 0100 |
| 8 | 1100 |
| 9 | 1101 |
| 10 | 1111 |
| 11 | 1110 |
| 12 | 1010 |
| 13 | 1011 |
| 14 | 1001 |
| 15 | 1000 |

One skilled in the art would understand how to extend this to any number of bits, including 8 bits. Using this notation, Z(i) can be applied directly to error correct 1 bit in B′(i) to create W_{INT}(i). W_{INT}(i) will then be one of B′(i)−1, B′(i), or B′(i)+1.

W_{INT}(i) is the estimate of B(i) after using the Hamming code to correct a measurement difference of 0 or 1 (i.e., a single bit error).

One skilled in the art would understand that other variants of Hamming codes and binary representations may be used for the measurement difference resolution encoder and decoder.

In an embodiment, instead of using a variant of a Hamming code for the measurement difference resolution encoder and decoder, the measurement difference resolution encoder may provide the n, for instance 3 or 4, least significant bits (lsbs) of the original enrollment biometric B as its output Z. For each B′(i) of the local biometric the measurement difference resolution decoder may find the value closest to B′(i) that has the same lsbs as in Z(i) from B(i).

Error Correction Code Description

A measurement difference resolution encoder and decoder (e.g., a Hamming code as described above) could be used alone as a secure sketch in which case output W″ would be set to W_{INT} in the secure sketch recovery module. However, for biometrics, due to a variety of occurrences, such as a scratch on a finger or an alignment issue, there may be some number of measurement errors uncorrectable by the measurement difference resolution code alone. Therefore, it may be advantageous to in parallel use an additional error correction code encoder and decoder (e.g., a Reed-Solomon code) to further correct some number of measurement errors caused by such occurrences. This holds for all embodiments of measurement difference resolution encoder and decoder.

In systematic Reed-Solomon codes, the code word symbols (i.e., the information passed) are viewed as the values of a polynomial pₓ(a) over a finite field F of size q. The polynomial pₓ(a) is sampled at n points (a₁, . . . , aₙ) to create n code symbols from k source symbols where n>k and n<q. Typically, n=(q−1) and q is a prime number. The n code symbols are transmitted and the receiver uses interpolation techniques to recover the original message.

The code words are constructed from the data as follows. The message x is divided into k components

x=(x₁, . . . ,xₖ)εF^{k}

where F^{k} is a finite field, for instance strings of binary bits of a certain length. The polynomial pₓ(a) is defined as:

pₓ(aᵢ)=xᵢ for all i=1, . . . ,k

Lagrange interpolation can be used to compute the coefficients of pₓ from x. Once pₓ has been found, it is evaluated at the other points of the field. These additional code word symbols are referred to as check symbols.

The set of code word symbols C(x) is the sequence of values:

C(x)=(pₓ(a₁(, . . . ,pₓ(aₙ))

However, the values pₓ(a₁), . . . , pₓ(aₖ) are the original data, in this case the enrollment biometric B. So, for the purposes of a secure sketch, only the additional code word check symbols pₓ(aₖ₊₁), . . . , pₓ(aₙ) are included in C, the error correction code encoder's contribution to the output of the secure sketch.

A Reed-Solomon code, can be used to encode W (whether in standard base 2 binary or modified binary representation) and decode W_{INT} to correct errors left over after application of a Hamming code as described above, creating the final W″. The Reed-Solomon decoder uses x₁, . . . , xₖ derived from the local biometric B′, after any resolution of measurement differences by the measurement difference resolution decoder, along with the check symbols derived by the Reed Solomon encoder to complete pₓ and then uses standard techniques known to one skilled in the art to correct up to (n−k)/2 additional symbol errors. In the example below, each symbol is one byte.

The strength of the Reed-Solomon code impacts the number of measurement errors that can be corrected, especially given that, unlike transmission errors, the check symbols are known to be correct, and therefore impacts the false positive and false negative rates. For instance, if n≧3k then (n−k)≧2k and solely the check bytes could be used to recreate the original k message symbols.

The use of the measurement difference resolution code may allow the use of a Reed-Solomon code such as a (36,32) Reed-Solomon code, shortened from a (255,251) code with 8-bit symbols by padding the 32 input symbols with 219 binary zero bytes. This code can correct up to 2 byte errors per 32 bytes of data. A FingerCode can be, for example divided up into 20 blocks of 32 bytes each and the Reed-Solomon code can be applied to each of these blocks individually. Note, however that the measurement difference resolution code and Reed-Solomon code are used in parallel and not as an inner and outer code in that the measurement difference resolution code output bits (e.g., lsbs or Hamming code parity bits) are not encoded by the Reed-Solomon code and the output of the Reed Solomon code is not input to the measurement difference resolution code.

Using a secure sketch function built from a combination of a bit correcting code, such as a Hamming code providing only parity bits, and a non-systematic error correction code such as a non-systematic Reed-Solomon code to encode a user's biometric data W allows the user's identity to be hidden when the biometric data is stored and exchanged. However, to increase security, there is a desire to limit the reuse of any single coded version of the exchanged information to circumvent storage of the exchanged information for unauthorized reuse. Additionally, there is a desire to protect against replacement of the coded version of one user's data with an appropriately coded version of a different user's data.

To achieve this increased security, a one-time use secure sketch is used. For instance, if a Reed-Solomon code is used in a secure sketch function to generate a secure sketch s, then as a function of time, T, one or both of the parameters n and k of the Reed Solomon code may be altered to create a different secure sketch. More or less of the biometric sample W may be included in the secure sketch. That is to say, as a function of time, W and W′ may be comprised of a subset of the measurements comprising B and B′, respectively. For instance, y<640 different measurements out of the 640 measurements comprising a FingerCode may be used as input to the secure sketch as shown in the subset selection module of the secure sketch and secure sketch recovery modules shown in FIGS. 6 and 7. The number y may be fixed and the chosen measurements vary with time or y may also vary with time. The secure sketch output may be padded so that all variations of the secure sketch produce a code word of the same length to reduce the ability to guess which variant was used. This makes it difficult to replace the user's coded biometric information with appropriately coded biometric data from a different user.

FingerCode and IrisCode have the property that order matters. That is to say that one must be matching an element of the enrollment biometric with the same element of the local biometric. Instead of, or in addition to, modifying the Reed-Solomon parameters or selecting a subset of the biometric as a function of time, in an embodiment the order the bytes of the FingerCode or IrisCode are processed into the measurement difference resolution code, and therefore the order of the output bits, may be modified as a function of time. In an embodiment, the bytes of the FingerCode or IrisCode are processed into the measurement difference resolution code in their original order and the order of the output bits may be reordered afterwards as a function of time. For FingerCode for example, this would produce 640 factorial (i.e., 640*639*638* . . . *2*1) possible orderings, making it practical to allow no one ordering to be used twice. One skilled in the art would understand how to use a function that generates uniform numbers as a function of T to generate the orderings.

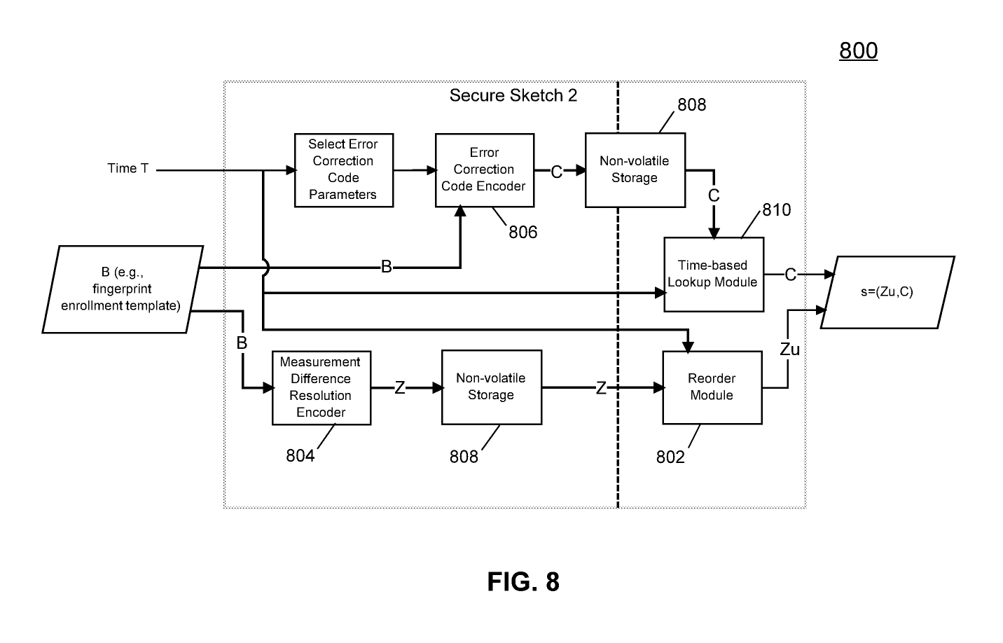

FIG. 8 shows an alternate embodiment of a secure sketch 800 that allows reordering of the output of the measurement difference resolution encoder 804. Where the secure sketch 600 in the FIG. 6 included the selection of a subset W of the enrollment biometric B as a function of time, the secure sketch 800 shown in FIG. 8 includes the reorder module 802 which reorders the output Z of the measurement difference resolution encoder 804, creating Zu. One skilled in the art would understand that reordering and selection of a subset of the biometric may both be performed in the same secure sketch.

In the secure sketch 800, an additional error correction code encoder 806, such as a Reed-Solomon described previously, is included. One skilled in the art would understand that this additional error correction code encoder 806 may be omitted. If the error correction code encoder 806 is present, it may optionally have its parameters changed based on time.

To support one-time or pseudo-one-time secure sketches, secure sketch 800 includes one or more non-volatile storage modules 808. During an enrollment stage, the measurement difference resolution encoder output, Z, may be stored in a non-volatile storage module 808 without compromising the identity or privacy of the person whose biometric B is being processed. During a later verification stage (e.g., when the person wants to access a secure device) the reorder module 802 retrieves Z from the non-volatile storage module 808, reorders the elements of Z based on time T, and outputs Zu.

If the secure sketch 800 also contains a time-based error correction code encoder 806, during an enrollment stage, to protect the person's identity and privacy, codewords C=(C1, C2, . . . , Cn) are generated from biometric B with parameters based on the possible values of time T from the equation T=F(Tₚ,T₀,X)=[(Tₚ−T₀)/X] modulo n where n is the one-time pad length. These codewords are stored in a non-volatile storage module 808. During a later verification stage, time-based lookup module 810 retrieves the appropriate codeword C to be included in the output of secure sketch 800. If error correction code encoder 806 is present, but is not time-based, a single codeword C is generated and stored in a non-volatile storage module during the enrollment stage and is retrieved and included in the output of secure sketch 800 in a later verification stage.

One skilled in the art would understand that the previously presented secure sketch 800 could include one or more non-volatile storage modules 808 and is split into enrollment and verification stages, but their description was left out to allow concentration of other aspects of the secure sketch. One skilled in the art would understand that the secure sketch 800 may share a non-volatile storage module with other functions. A non-volatile storage module may take the form of a file on disk, a file or entries in flash memory, or other forms of non-volatile storage as would be known to one skilled in the art.

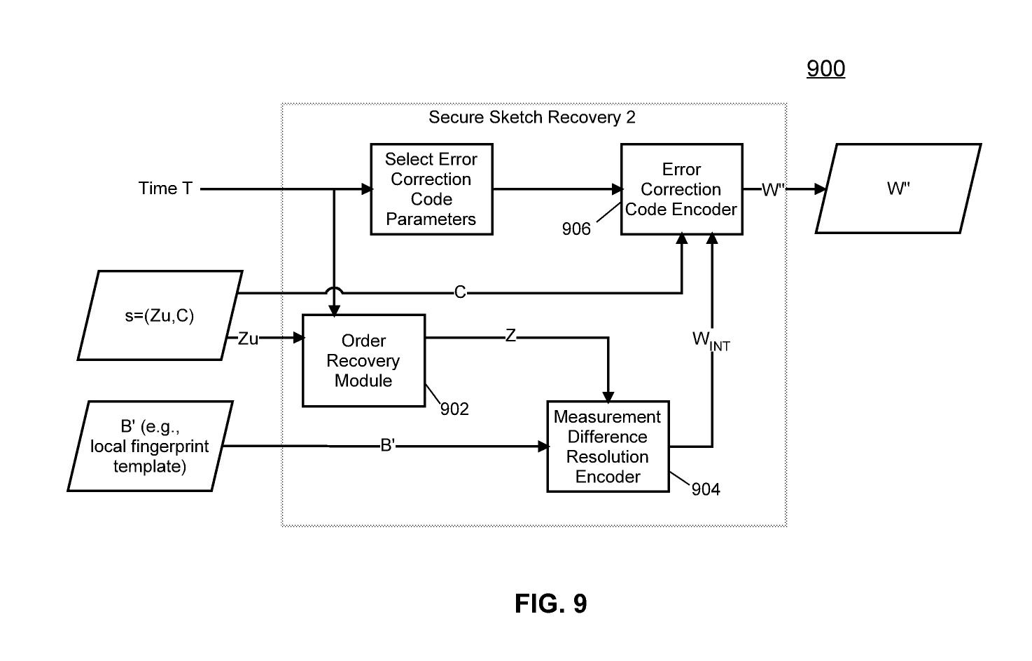

FIG. 9 shows the corresponding secure sketch recovery 900. Secure sketch recovery 900 contains an order recovery module 902 that accepts Zu, determines the reordering necessary based on T, and puts the elements of Zu back into the original order, creating Z. Z is then input to the measurement difference resolution decoder 904 which is the corresponding decoder for the measurement difference resolution encoder 804 used in secure sketch 800. If secure sketch recovery 900 additionally contains an error correction code decoder 906 corresponding to the error correction code encoder 806 of secure sketch 800, error correction code decoder 906 is applied to W_{INT}, the output of the measurement difference resolution decoder 904. If error correction code decoder 906 is time based, the correct parameters, as a function of time, are used.

There may be a finite number of practical variations in the aspects chosen to vary with time, so to have s remain a one-time secure sketch may require periodic re-authentication of the user by collecting a new sample W. In an embodiment, a number of instances or a pad of instances of secure sketch s may be created from W and stored at security server 102, each using different secure sketch function (e.g., byte subset) parameters. A different instance is chosen as a function of time, T, with cycling or reuse allowed, creating a pseudo one-time use secure sketch. Instances from the list may be selected in time order. The use of a private time base as described above for one-time use keys, allows further obfuscation of the selection of the particular instance of the secure sketch s, reducing the ability to predict which variant of secure sketch s was used (i.e., which parameters were used to generate s), reducing the ability of an attacker from replacing the secure sketch s with a similarly parameterized secure sketch from a different person.

Robust Fuzzy Extractor

The above tools may be used in a novel version of a fuzzy extractor to allow a remote device, such as user terminal 104 or secure device 106, with aid from a security server 102, to allow access via biometric identity verification, allow decryption of a message using a biometric derived key, or both.

A fuzzy extractor is composed of two parts. The first part is a generator function Gen(B) that takes an input B and produces a string R which is close to uniform and a helper string P. The second part is a reproduction function Rep(B′,P) which uses helper string P to create a reproduction of B (or its subset or alternative representation, W) from an input B′ sufficiently close to B allowing reproduction of the string R. Helper string P may be a secure sketch or a function of a secure sketch. Since R is close to uniform, it has good qualities for use as an encryption key. If the fuzzy extractor uses hash functions or other functions with similar characteristics as described above, preferably a first for verification that the reproduction of B from B′ equals B (or its subset or alternative representation, W) and a second for the generation of R, then the fuzzy extractor is a robust fuzzy extractor.

Generator Function

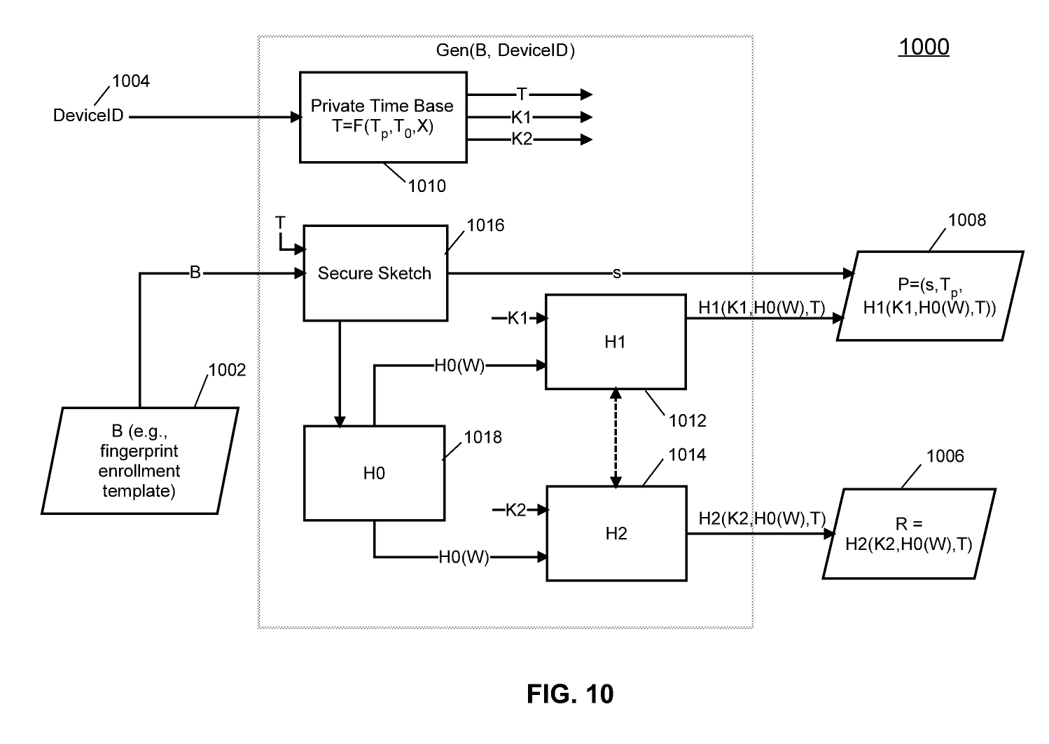

FIG. 10 is a block diagram of a novel helper string generator module 1000, which may implement a generator function such as Gen(B,DeviceID), for example. The functionality of helper string generator module 1000 may be performed by security server 102, for instance using a combination of processor 402 and storage 404. A biometric B 1002, taken from a user during enrollment, is an input to the generator function 1000. Additionally, an optional device ID, DeviceID 1004, may be input. Outputs are an encryption key R 1006 that may be used to encrypt a message from security server 102, for example more detailed access rights, to a device, such as user terminal 104 or secure device 106, and a helper string P 1008 that helps the device recreate encryption key R 1006 for use in decrypting the message received from security server 102. Helper string P 1008 may also be used to verify the right of a user to access the device 104, 106.

In addition to identifying the secure device the user wishes to access, DeviceID 1004 is used to derive device dependent parameters. For instance, DeviceID 1004 may be used in a Private Time Base module 1010 to determine device dependent values of shared secret time base parameters T₀ and X used in generating time, T. Additionally, hash functions H1 1012 and H2 1006 may use device dependent shared secret keys K1 and K2 as inputs. Also, the secure sketch module 1016 (e.g., secure sketch 600) may use device dependent parameters. DeviceID 1004 may be the actual device ID of device 104, 106 or may be a function of its actual device ID (e.g., a hash).

Biometric B 1002 is input to the secure sketch function 1016 to create secure sketch, s. As described above, a list or pad of secure sketches may be generated using different secure sketch parameters for each instance. A secure sketch or a list or pad of secure sketches may be generated during the user enrollment phase, eliminating the need to store biometric B 1002, thus adding privacy for the user, or they may be generated on demand during the verification phase from a stored copy of biometric B 1002. These secure sketch instances may be stored in storage 404 of security server 102 and retrieved based on time parameter T. Biometric subset W of B (or B in an alternate embodiment), is also used as input to hash function H0 1018 the output of which feeds into hash modules H1 1012 and H2 1014 to create the access validation portion of string P 1008 and the string R 1006, respectively.

Storing the secure sketches and H0(W) allows B, and its subset or function W, to be discarded once the sketches and H0(W) are created, protecting the user's identity. In an alternate embodiment where B or W are stored or a new B is collected each time helper string generator module 1000 operates, the secure sketches do not need to be stored and H0(W) may be made unnecessary by feeding W (or B) directly into hash modules H1 1012 and H2 1014.

The private time base module 1010 creates a time value that may be used to create one-time keys, such as time-based outputs of hash functions and one-time or pseudo one-time secure sketches. The private time base module 1010 chooses a private time value Tₚ. Tₚ may be created in a number of ways. For instance, Tₚ may be Greenwich Mean Time, Universal Time, local wall clock time at the security server 102, wall clock time at the secure device 104, 106, a random number, or chosen specifically to cause a certain one-time pad entry or certain one-time secure sketch to be used. Tₚ may be represented using any of a number of time steps, such as second, minutes, milliseconds, etc. The private time base module uses Tₚ to create a time T for use by other modules. In an embodiment, the private time base module uses parameters specific to secure device 104, 106 to generate time T from Tₚ. For instance, the private time base module 1010 may use secure device specific values for T₀ and X to create T using the equation T=[(Tₚ−T₀)/X] or T=[(Tₚ−T₀)/X] modulo one-time pad length. In embodiments using a private time base, private time value Tₚ is included in helper string P to allow the reproduction function in secure device 104, 106 to recreate T from Tₚ and device specific values T₀ and X.

The secure sketch module 1016 takes biometric sample B 1002 as input and applies an appropriate one-way function such that recovery module output (Rec(B′,s))=B, or its subset or function W, for B′ sufficiently close to B. In an embodiment the one-way function is a Hamming code and an optional Reed-Solomon code applied to the well-known six hundred-forty (640) element FingerCode feature vector or a variant as noted in pages 220-221 of “Handbook of Fingerprint Recognition,” Davide Maltroni, et al., copyright 2009. In an alternate embodiment the one-way function is a Hamming code and an optional Reed-Solomon code applied to the well-known two hundred-fifty-six (256) element IrisCode. The secure sketch output s is included in helper string P 1008 of the output of helper string generator module 1000. In an embodiment, one or more of the parameters of the secure sketch, such as the subset W of biometric B or n and k of the Reed-Solomon code, may be modified to create a number of secure sketches based on the same biometric. The time value T calculated by the private time base module 1010 may be used to choose the secure sketch instance to include in helper string P 1008.

The hash function module H0 1018 is used to create H0(B) or H0(W), a function of biometric B 1002 or subset W that may be used as input to other modules in place of biometric B 1002 or subset W, allowing protection of the user's identity by eliminating the need to store biometric B 1002 or subset W after H0(W) and secure sketch output s are calculated. Since the purpose of H0 1018 is to eliminate the need to store W, in an embodiment H0 1018 does not have time parameter T as an input and does not use a secure device specific parameter such as a shared secret key. In an embodiment, multiple H0(W) values are created based on possible values of T satisfying T=[(Tₚ−T₀)/X] modulo one-time pad length, making H0(W) a form of one-time pad. In an embodiment, multiple H0(W) values are created based on shared secrets for a plurality of secure devices, allowing a device specific version of H0(W) to be used in calculations by other modules.

The hash function module H1 1012 is used to generate a part of string P 1008 that may be used to confirm access rights of the user to secure device 104, 106 based on biometric subset W. In an embodiment that uses hash function H0 1018, hash function H1 1012 takes H0(W) as an input. In an embodiment that does not use hash function H0 1018, hash function H1 1012 takes biometric subset W as an input. One skilled in the art would understand that other functions of biometric B 1002 could be used in place of H0(W) or W itself. In an embodiment, hash function H1 1012 takes time as an input allowing its output to be one-time or limited-time use. In an embodiment, hash function H1 1012 takes the time value T generated by the private time base module 1010 as a time input. In an embodiment, hash function H1 1012 uses a shared secret key, K1, known to both security server 102 and secure device 104, 106. In an embodiment, shared secret key K1 is specific to secure device 104, 106 and security server 102 determines K1 based upon receiving the device ID of secure device 104, 106. For an embodiment, the output of hash function H1 1012 is denoted as H1(K1,H0(W),T), which may serve as a one-time access verification code generated with a private time base. One skilled in the art would understand that additional information may be used as input to hash function H1 1012, for instance secure sketch function output s.

The hash function module H2 1014 is used to generate string R 1006 that may be used to encrypt, based on biometric B 1002 or a function thereof, messages transferred to secure device 104, 106. In an embodiment that uses hash function H0 1018, hash function H2 1014 takes H0(W) as an input. In an embodiment that does not use hash function H0 1018, hash function H2 1014 takes biometric B 1002 or a subset Was an input. One skilled in the art would understand that other functions of biometric B 1002 could be used in place of H0(W), W, or B itself. In an embodiment, hash function H2 1014 takes time as an input allowing its output to be one-time or limited-time use. In an embodiment, hash function H2 1014 takes the time value T generated by the private time base module 1010 as a time input. In an embodiment, hash function H2 1014 uses a shared secret key, K2, known to both security server 102 and secure device 104, 106. In an embodiment, shared secret key K2 is specific to secure device 104, 106 and security server 102 determines K2 based upon receiving the device ID of secure device 104, 106. For an embodiment, the output of hash function H2 1014 is denoted as H2(K2,H0(W),T) which may be alternately denoted as R and which may serve as a one-time key with a private time base. One skilled in the art would understand that additional information may be used as input to hash function H2 1014, for instance secure sketch function output s.

In an embodiment, one or both of H1 1012 and H2 1014 use HOTP, TOTP, or another well-known counter-based or time-based one-time key function.

Helper string generator module 1000 has output strings P 1008 and R 1006. Output R 1006 may be used as an encryption key to encrypt a message from security server 102 to secure device 104, 106. Output P 1008 is a helper string that may be used by secure device 104, 106 to recreate encryption key R 1006 for use in decrypting the message received from security server 102. Helper string P 1008 may be used to aid in verifying the right of a user to access secure device 104, 106. In an embodiment, helper string P 1008 contains the secure sketch output s, the private time base parameter Tₚ, and the H1 access control hash function module output H1(K1,H0(W),T). Helper string P 1008 is transferred from security server 102 to secure device 104, 106, but encryption key R 1006 is not transferred to secure device 104, 106.

One skilled in the art would understand that if there is no need to transfer a message encrypted based on biometric B 1002, but to only grant access, hash function module H2 1014 and output R 1006 may be omitted. One skilled in the art would understand that if there is no need to grant access to a device, but to only transfer a message encrypted based on biometric B 1002, hash function module H1 1012 and inclusion of its result in helper string P 1008 may be omitted, however H1 1012 may still be used to determine whether a local biometric sample, B′ collected at secure device 104, 106 (see reproduction function description below), is sufficiently close to B 1002 and to gate the application of R 1006, that is to grant access to the right to attempt to decrypt any message encrypted using R 1006. H1 1012 may also be used to determine that B′ is not sufficiently close to B 1002 prompting a retry of the collection of the local biometric B′.

If there is a desire to transfer a message encrypted based on biometric B 1002 from security server 102 to secure device 104, 106, the message is preferably transmitted within the time window of validity of encryption key R 1006. In an embodiment, secure device 104, 106 will only attempt decryption of a message encrypted using R 1006 if the message is received within a certain time window of receiving helper string P 1008. In an embodiment, this time window has duration equal to or a function of shared private time base secret X.

The encrypted message may contain any content security server 102 may wish to transfer to secure device 104, 106 encrypted by a function of biometric B 1002. For instance, if secure device 104, 106 is a multi-drawer safe, the encrypted message may provide information regarding which drawers of the safe the user may access. In another example, if additional security is desired, the message may contain user specific challenge questions and corresponding answers.

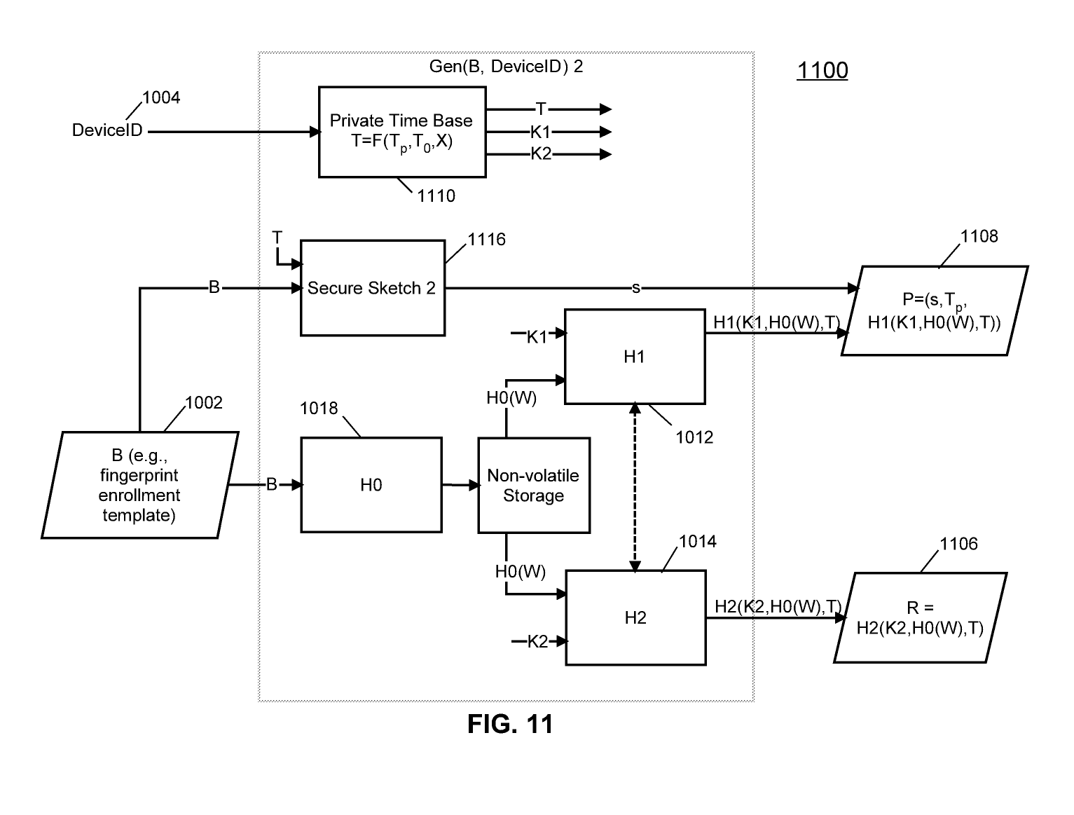

FIG. 11 shows an alternative type of helper string generator module 1100, referred to as a Gen( )2 module, which implements a Fuzzy Extractor Gen( )2 function and which incorporates secure sketch 800.

Since this Gen( )2 module 1100 incorporates secure sketch 1116 (i.e. secure sketch 800) in place of secure sketch 1016 (i.e. secure sketch 600), H0 1018 now operates directly on biometric B 1002 rather than on subset biometric W (since B 1002 is a subset of itself, the notation H0(W) is kept for the output of H0 1018 to clarify that Gen ( ) 1000 and Gen( )2 1100 operate the same after H0 1018). For clarity, the above figure also shows that the output of H0 1018 may be stored in a non-volatile storage module 1102 eliminating the need to store B 1002 and protecting the enrollee's identity and privacy. One skilled in the art would understand that the previously presented Gen( ) function 1000 could also include a non-volatile storage module in which to store a pad of outputs H0(W) for one or more subsets W of B 1002. The non-volatile storage module 1102 may be the same as or different than that used by secure sketch 800. One skilled in the art would understand that the input to function H0 1018 in Gen( ) 1100 may be a subset biometric W, as described in the operation of Gen( ) 1000.

Reproduction Function

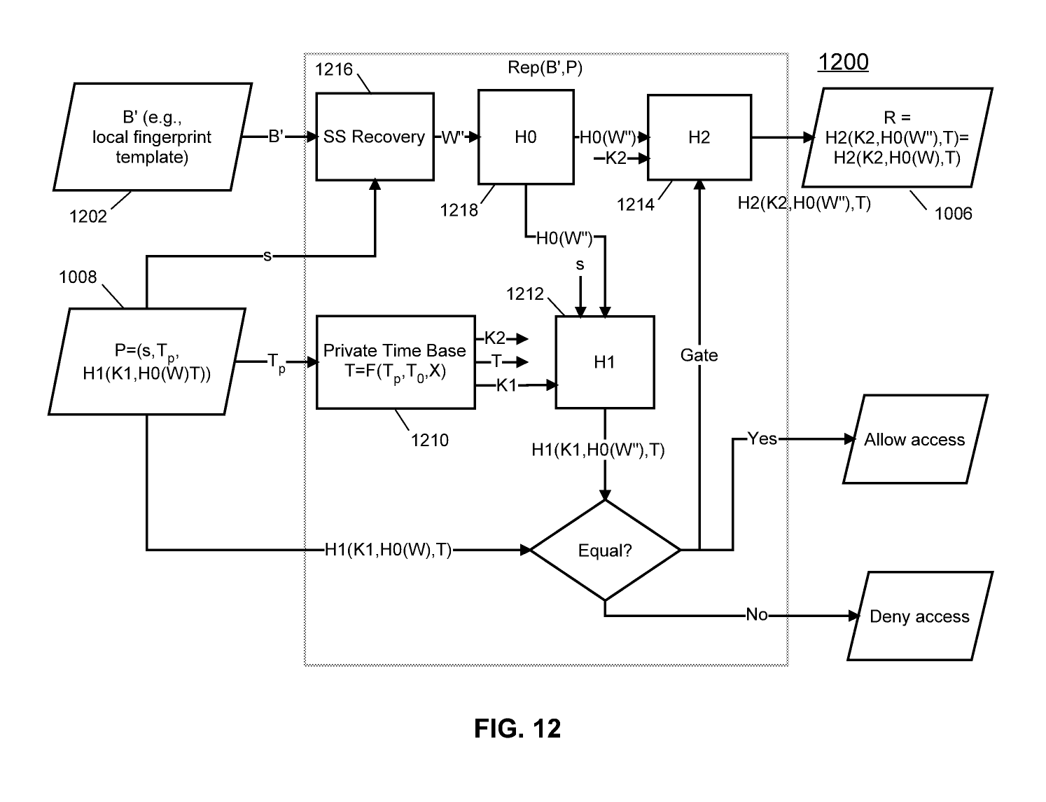

FIG. 12 shows a novel reproduction/validation module 1200, which may implement function Rep(B′,P) for example. Reproduction/validation module 1200 may be performed by a secure device (e.g., user terminal 104, secure device 106), for instance using a combination of a processor, a storage, and a biometric sampler. A local biometric, B′ 1202, for instance taken using biometric sampler module 226, 308, and helper string P 1008 from security server 102 are inputs. Secure device 104, 106 may use reproduction/validation module 1200 to recreate encryption key R 1006 for use in decrypting a message received from security server 102. Helper string P 1008 may be used in verifying the right of a user to access secure device 104, 106.

Helper string P 1008 is separated into its components, secure sketch output s, private time base parameter Tₚ, and H1 access control hash function output H1(K1,H0(W),T). Private time base parameter Tₚ is used in a private time base module 1210 to recreate time parameter T. Private time base module 1210 may use the same equations as used by the private time base module 1010 in the generator function 1000 of security server 102. However, in an embodiment, the private time base module 1210 in secure device 104, 106 may retrieve the shared secret time base parameters T₀ and X from a non-volatile portion of storage module 1220 without the aid of the device ID of secure device 104, 106. In an embodiment, private time base parameter Tₚ is used to set an internal clock in secure device 104, 106 and private time base module 1210 uses the time from this clock rather than using private time base parameter Tₚ directly, ensuring that inputs to other modules that also use time value T will be valid for a time duration equal to or a function of private time base shared secret parameter X.

Secure sketch output s and locally collected biometric B′ 1202 are inputs to the secure sketch (SS) recovery module 1216 (e.g., secure sketch recovery module 700). If the secure sketch was a one-time or pseudo one-time secure sketch, time parameter T is also an input to the SS recovery function 1216, allowing the SS recovery function 1216 to perform recovery using the appropriate parameters based upon T. The SS recovery function 1216 uses secure sketch output s to create output W″ from input local biometric sample B′ 1202. If B′ 1202 is sufficiently close to the enrollment biometric B 1002 that was used to generate secure sketch output s, then W″ will equal subset W of B. In an embodiment, the secure sketch and secure sketch recovery modules are as previously described in this document.

Hash function modules H0 1218, H1 1212, and H2 1214 in the reproduction function in secure device 104, 106 are the same as those used in the generator function 1000 in security server 102. All features are the same. For instance, if H1 1012 and H2 1014 in the generator function 1000 accept time parameter T as an input, then H1 1212 and H2 1214 in the reproduction function 1200 accept time parameter T as an input. If H1 1012 and H2 1014 in the generator function 1000 accept the output of H0 1018 as an input, then H1 1212 and H2 1214 in the reproduction function 1200 accept the output of H0 1018 as an input and H0 1218 is a part of the reproduction function 1200. Conversely, if H1 1012 and H2 1014 in the generator function 1000 accept the biometric sample 1002 as an input directly, then H1 1212 and H2 1214 in the reproduction function 1200 accept the biometric sample 1202 as an input directly and H0 1218 may not be a part of the reproduction function 1200. Additionally, if messages encrypted using key R 1008, based on the biometric B 1002, are not transferred, H2 1214 may not be necessary. Similarly, if H1 1012 is not used for secure device access, for determining the equivalence of W′ to W, or as a gate for generation of key R, H1 1212 may not be necessary.

If hash function H0 1018 is used, SS recovery module output W″ is used in hash function H0 1218 to create H0(W″). In an embodiment, SS recovery output W″ is used as input to hash function H1 1212. In an embodiment, hash function H0 output H0(W″) is used as input to hash function H1 1212. In an embodiment, time value T is used as input to hash function H1 12121 and shared secret key K1 is used as input to hash function H1 1212. In an embodiment, time value T is based on a private time base 1210 and key K1 is a shared secret key specific to secure device 104, 106.

The output of reproduction function hash function H1 1212, e.g., H1(K1,H0(W″),T), is compared to the portion of helper string P 1008 containing the output of generator function hash function H1 1212, e.g., H1(K1,H0(W),T). If local biometric sample B′ 1202 is sufficiently close to original biometric sample B 1002, these will be equal and access to secure device 104, 106 may be granted. If local biometric sample B′ 1202 is not sufficiently close to original biometric sample B 1002, the output of the two instances of H1 1012, 1212 will not be equal and access to secure device 104, 106 may be denied. In an embodiment, the user may be prompted to retry the collection of the local biometric B′ 1202 some number of additional times. Additionally, if time parameter T used by the reproduction function 1200 does not correctly correspond to time parameter T used by the generator function 1000 the output of the two instances of H1 1012, 1212 will not be equal and access to secure device 104, 106 may be denied.

In an embodiment, SS recovery output W″ is used as input to hash function H2 1214. In an embodiment hash function H0 output H0(W″) is used as input to hash function H2 1214. In an embodiment time value T is used as input to hash function H2 1214 and shared secret key K2 is used as input to hash function H2 1214. In an embodiment time value T is based on a private time base 1210 and key K2 is a shared secret key specific to secure device 104, 106.

If local biometric sample B′ 1202 is sufficiently close to original biometric sample B 1002, the output of reproduction function hash function H2 1214, e.g., H2(K2,H0(W″),T), will be equal to encryption key R=H2(K2,H0(W),T) and messages encrypted using encryption key R 1006 may be decrypted. If local biometric sample B′ 1202 is not sufficiently close to original biometric sample B 1002, the output of the two instances of H2 1014, 1214 will not be equal and encryption of a message encrypted using R 1006 may be unsuccessful. Additionally, if time parameter T used by the reproduction function 1200 does not correctly correspond to time parameter T used by the generator function 1000 the output of the two instances of H2 1014, 1214 will not be equal and encryption of a message encrypted using R 1006 may be unsuccessful.

In an embodiment, to enhance security, inputs and intermediate results such as B′, W′, W_{INT}, W″, H0(W″), and the outputs of H1 1212 and H2 1214 are only in volatile memory and are not stored after use. Additionally, inputs and intermediate results such as those listed above may be stored in tamper resistant memory devices protected against unauthorized access and usage within storage.

An alternative reproduction/validation module (Fuzzy Extractor Reps) for use with the alternative helper string generator module (Gen( )2) 1100 differs from the previously presented reproduction/validation module 1200 only in the inclusion of the secure sketch recovery 2 module 900 rather than the secure sketch recovery module 700 and will not be shown here. One skilled in the art would understand that the reproduction/validation function must contain the secure sketch recovery module that corresponds to the secure sketch module used in its respective helper string generator module.

System Event Flow

Ensuring Quality Enrollment Fingerprint

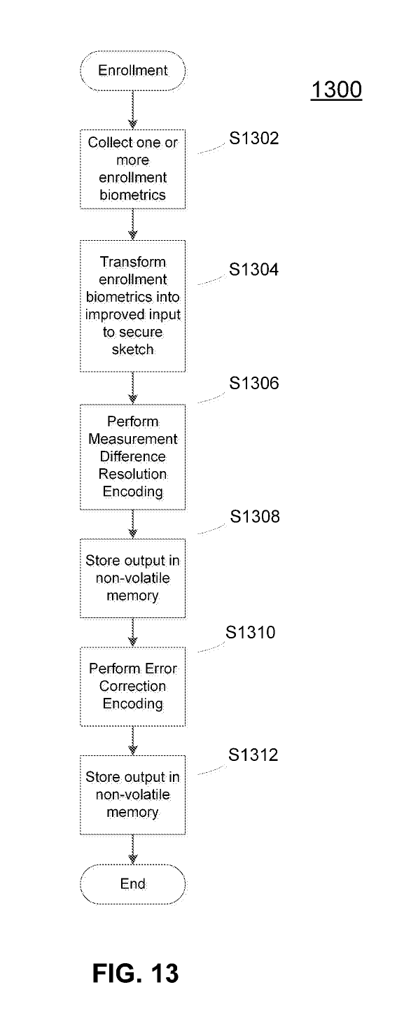

FIG. 13 shows an embodiment of a biometrics enrollment process. A goal during enrollment is to process the enrollment biometric into a form that not only eliminates the need to store the enrollment biometric but hides the enrollee's identity if the secure server 102 is compromised.

The enrollment process 1300 starts with the collection of one or more biometric samples in step S1302. In an embodiment, up to three fingerprint samples are collected.

In step S1304, the biometric samples are transformed into an improved input to the secure sketch. In an embodiment, this transformation includes transforming one or more of the biometrics samples into a transformed enrollment biometric, such as fingercodes as described above. In an embodiment, the transformed enrollment biometric may be further transformed as a function of time to create a time-based transformed enrollment biometric for use as input to the secure sketch.

To improve the secure sketch input, the best biometrics sample may be chosen. In an embodiment, software that is available and known to one skilled in the art, such the National Institute of Standards and Technology (NIST) Fingerprint Image Quality (NIFQ) software and which is available for free download, may be used to assess the quality of fingerprint biometrics and ensure that the fingerprint chosen for transformation is of a certain quality. In an alternate embodiment, the first fingerprint exceeding a quality threshold is chosen to be transformed into a fingercode. In another alternate embodiment, a number of fingerprint samples are acquired and the one with the highest quality score is chosen to be transformed into a fingercode.

Alternatively, in step S1304, the one or more biometric samples are transformed into a form suitable for input to the secure sketch, and these transformed biometrics are used to create the best secure sketch input. In an embodiment, a number, for instance 3, of enrollment fingerprint samples are taken. The enrollment fingerprints are all processed into inputs to the secure sketch, for instance into fingercode 1, finger code 2, and fingercode 3. The three fingercodes are then processed by the secure sketch. Each is used to recover the other two. For instance finger code 1 is used to correct fingercodes 2 and 3. Fingercode 2 is used to correct fingercodes 1 and 3, and finger code 3 is used to correct fingercodes 1 and 2. The number of corrected samples is determined, for instance, by determining the number of corrected samples returned when using a Reed-Solomon correction code. A fingercode may be chosen as the “best” input to the secure sketch by evaluating the number of corrected samples in the procedure described above. The best fingercode is the fingercode which can be used to recover the other fingercodes using the fewest number of corrections. In an embodiment, the number of corrections for the fingercode requiring the fewest number of corrections must be below a threshold. If the number of corrections is not below the threshold, the set of fingercodes is considered to be too low in quality and another biometric sample must be taken, for instance replacing the fingercode that required the greatest number of corrections to recover the other fingercodes.

In an alternate embodiment, two or more fingercodes are averaged and tested for their ability to correct the fingercodes derived from the original fingerprints. In another alternate embodiment, all of the fingercodes are averaged and used as the input to the secure sketch.

One skilled in the art would understand how more or fewer biometric samples may be used in the embodiments described.

At step S1306, the measurement difference resolution encoding step of the secure sketch is performed. In an embodiment, a Hamming code is calculated for the samples of a fingercode. In an alternate embodiment, one or more least significant bits are extracted. The output of step S1306 is stored in non-volatile memory at step S1308.

At step S1310, the error correction encoding step of the secure sketch is performed. In an embodiment, one or more parity symbols for a systematic Reed-Solomon code are calculated for a fingercode using some number, including all, of the most significant bits of the fingercode. The output of step S1310 is stored in non-volatile memory at step S1312.

Improving the Confidence of Identification

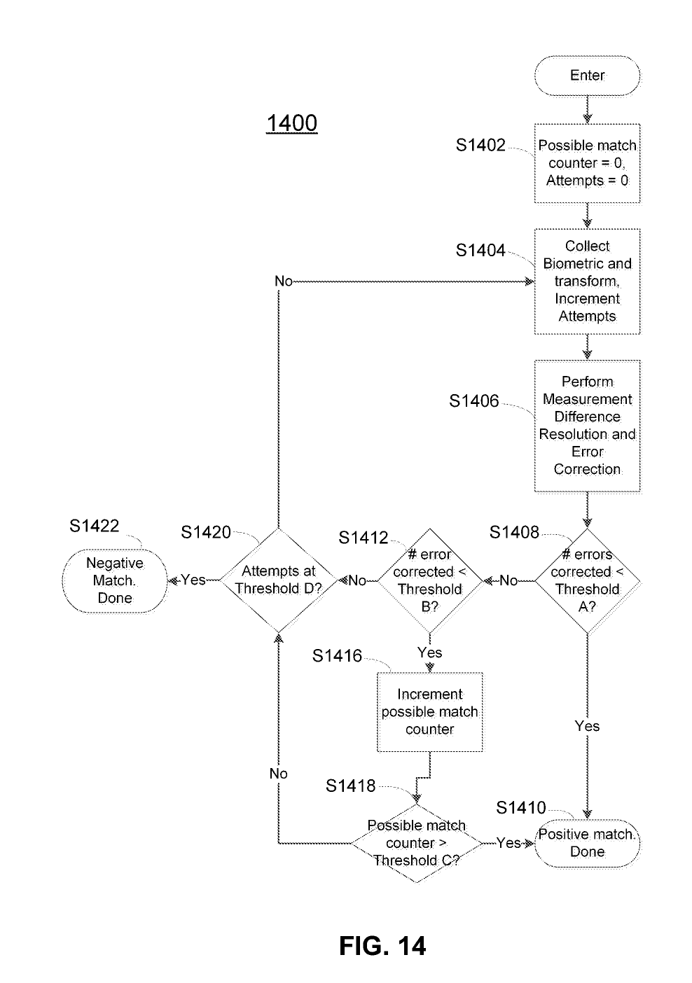

In an embodiment, when a local biometric (e.g., a fingerprint) is transformed (e.g., into a fingercode) by a secure device in order to recover the transformed enrollment biometric (e.g., fingercode of the enrollment fingerprint), a method, as shown in FIG. 14, is used to improve the confidence in the decision whether the local biometric is truly from the person who enrolled the enrollment biometric.

To improve this confidence, the error correcting code of step S1310 is an error correcting code that can determine the number of errors actually corrected. In an embodiment, a systematic Reed-Solomon code is used. For example, the need to correct fewer errors may indicate a higher confidence in a positive match while the need to correct more errors may indicate a lower confidence in a positive match. A low confidence match combined with a number of failed attempts to match may still be considered, for instance, a failure match, while a single high confidence positive match may be sufficient to declare a positive match.

The process begins, at step S1402, by setting the value of two counters, a possible match counter and an attempts counter, to zero. At step S1404, a biometric sample is collected and transformed, and the attempts counter is incremented. Measurement difference resolution and error correction is performed at step S1406, in a manner compatible with the encoding performed in steps S1306 through S1312 of FIG. 13.

Four thresholds and parameters may be used. At step S1408, the processor determines whether the number of errors corrected is less than a pre-determined threshold A. Threshold A is the number of corrections of the transformed local biometrics below which a positive match of the local biometric with the enrollment biometric is highly likely. If the number of errors corrected is less than threshold A, a positive match is confirmed at step S1410 and the process ends.

However, if the number of errors corrected is greater than or equal to threshold A, at step S1408, the processor determines, at step S1412, whether the number of errors corrected is below a predetermined threshold B. Threshold B is the number of corrections of the transformed local biometrics below which a positive match of the local biometric with the enrollment biometric is possible, but with low confidence. If the number of errors corrected is less than threshold B, the possible match counter is incremented, at step S1416, and the processor determines, at step S1418, whether the value of the possible match counter equals a pre-determined threshold C. Threshold C is the minimum number of local biometrics with a number of corrections of the transformed local biometrics below threshold B that are required, in the absence of a local biometrics with corrections of the transformed local biometrics below threshold A, to increase confidence in a positive match to highly likely.

If the number of errors corrected is greater than threshold B, at step S1412, or the value of the possible match counter is less than threshold C, at step S1418, the processor proceeds to determine, at step S1420, whether the number of attempts is at threshold D. Threshold D is the maximum number of attempts allowed without either of:
1. a transformed local biometric with required corrections below threshold A, or
2. the number of transformed local biometric with required corrections below threshold B equaling threshold C.

If the number of attempts has reached threshold D, at step S1420, a negative match is confirmed, at step S1422, and the process ends. However, if the number of attempts is less than threshold D, at step S1420, the process returns to step S1404 to collect and transform another biometric sample and increment the attempts counter. The process will execute until the user has been positively or negatively confirmed.

In an alternative embodiment, step S1420 may be replaced with a test whether the difference between threshold D and the current number of attempts is less than the difference between threshold C and the current number of possible matches. This would sometimes allow the method to end using fewer local biometrics since there are conditions when there are attempts left, relative to threshold D, but too few to allow the possible match counter to exceed threshold C.

In an embodiment, fingerprints are transformed into fingercodes using four (4) bands, sixteen (16) sectors, and bank of eight (8) Gabor filters with different orientation angles producing five hundred twelve (512) 9-bit samples. A Measurement Difference Resolution encoding is chosen in step S1306 to extract a number of least significant bits of the 9-bit sample. The parity symbols of systematic Reed-Solomon code capable of correcting at least one hundred twenty-five (125) errors in the five hundred twelve (512) sample fingercode is used as the error correcting code of step S1310 and applied to a number of the most significant bits of the fingercode. Threshold A is chosen to be one hundred fifteen (115). Threshold B is chosen to be one hundred twenty-five (125). Threshold C is chosen to be three (3). Threshold D is chosen to be five (5).

System Event Flow where the User Terminal is the Secured Device

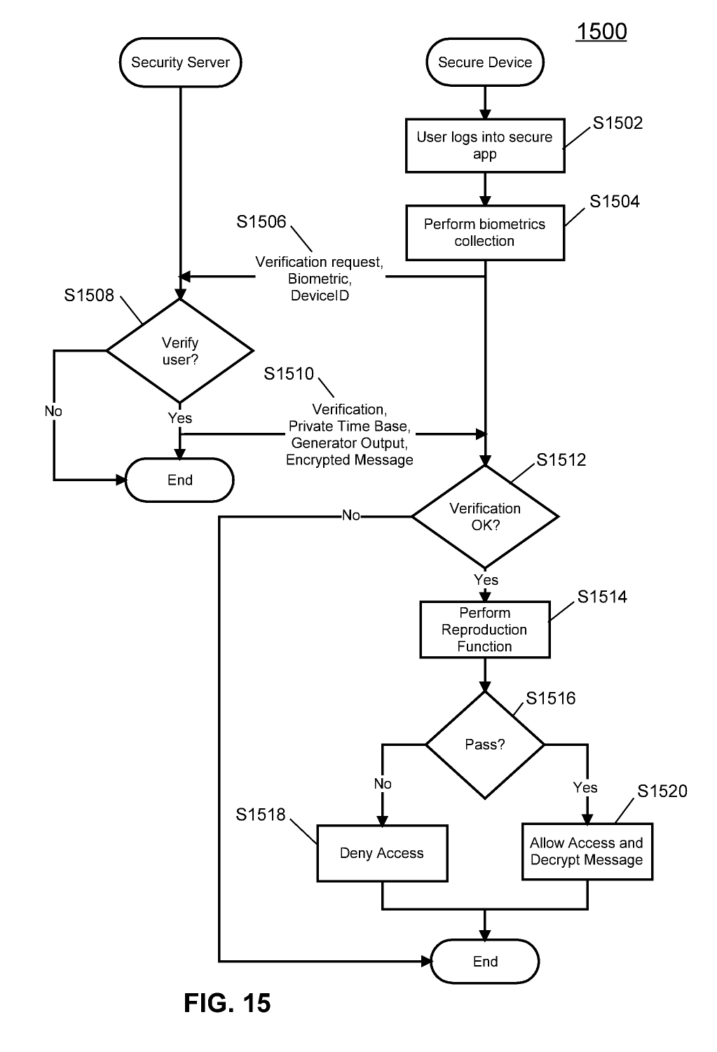

FIG. 15 shows the flow of events and interactions between a user terminal 104 and security server 102 during verification of a user in an embodiment where the user terminal 104 is the secured device requesting access. The order of events is for example purposes only and one skilled in the art would understand which events may be reversed or otherwise rearranged in order. One skilled in the art would understand that the transfer of information between devices may be encrypted to further enhance security.

The events are initiated by the user's desire to access a secure device. The user may log into, at step S1502, a secure application (app), such as App 120, on a registered smartphone or other user device, such as user terminal 104. The user terminal 104 may retrieve the device ID from the storage 210 in the user terminal 104. The user may perform a biometric sample collection, at step S1504, on the user terminal 104, for instance using camera 212 and user interface 208 as described in co-pending U.S. patent application Ser. No. 13/743,149, cited above. In an embodiment, the biometric is used in lieu of a login to the secure app. In an embodiment the login credentials are used in lieu of the user terminal 104 collected biometric sample. Note that the biometric sample collected at step S1504 should not be the same biometric used in step S1514 described below.

A verification request along with verification information, e.g., biometric collected on user terminal, login credentials, or both, is transferred, at step S1506, to the security server 102, for instance via cellular communications, along with the collected device ID of the secure device (i.e. user terminal 104). The security server 102 performs a verification of the user and returns the results. If the security server's verification of the user is unsuccessful, at step S1508, the activity terminates. If the security server's verification of the user is successful, at step S1508, the security server 102 performs a post-enrollment (i.e., verification stage) portion of the generator function and also returns, at step S1510, the helper string P, containing for instance private time base Tₚ, secure sketch output s, and the output of hash function H1 where s and the output of H1 are based upon a previously obtained biometric sample of the user. In addition, if the security server's verification of the user is successful, at step S1508, the security server 102 may also return one or more message encrypted using string R, the output of hash function H2 based upon a previously obtained biometric sample of the user.

If the security server 102 indicates verification was successful, at step S1512, the user terminal 104 collects a biometric locally and performs the reproduction function 1200, at step S1514, to determine if the locally collected biometric is sufficiently close to the original biometric used by the security server 102 to recover the original biometric and, therefore, to recover key R. If it is not sufficiently close, at step S1516, access to the secure device is denied, at step S1518, or some number of retries is initiated. If it is sufficiently close, at step S1516, access to the secure device 104 is allowed, at step S1520, and any accompanying messages encrypted with key R are decrypted.

Device Flow Charts for System where the User Terminal is the Secured Device

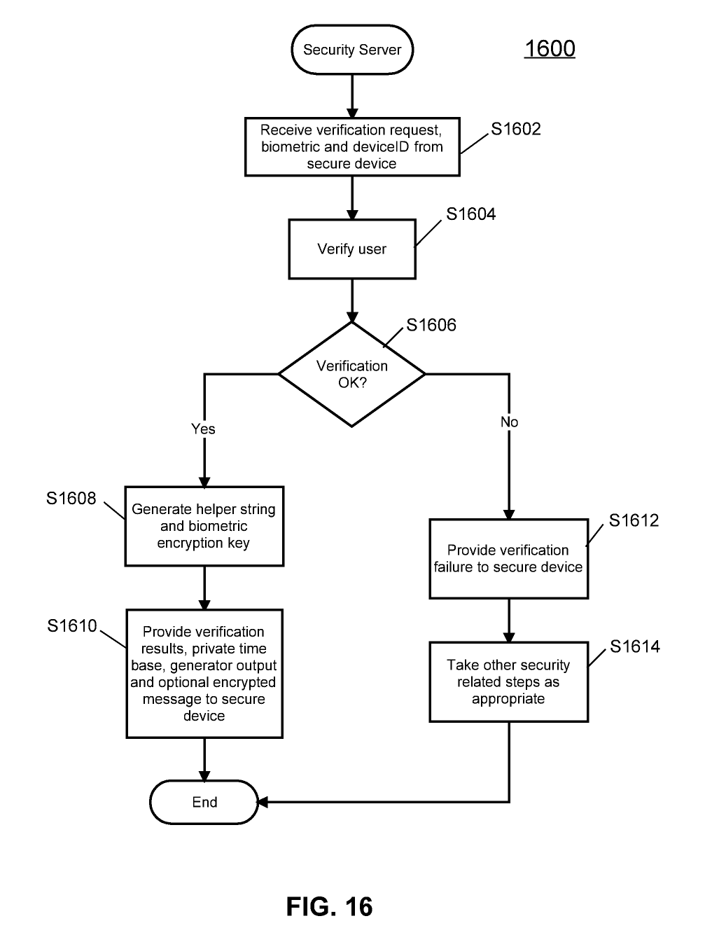

FIG. 16 depicts the verification stage flowchart 1600 for a security server such as security server 102. One skilled in the art would understand that the transfer of information between devices may be encrypted to further enhance security, some operations may be optional, and that the order of some operations may be changed.

The security server 102 receives, at step S1602, for instance via cellular communications, a verification request including a biometric, user login credentials, or both from a user terminal 104. Additionally, the security server 104 may receive an identifier of the device the user wishes to access (i.e. user terminal 104). The security server 102 uses the information received with the verification request to verify, at step S1604, the user's identity and to verify that the user has rights to access the requested secure device 104.

If the verification of the user's identity and right is successful, at step S1606, the security server 102 performs, at step S1608, the verification portion of a robust fuzzy extractor generator function as described above, based on a previously collected biometric B of the user compatible with the capabilities of the requested secure device 104, generating helper string P and generating an encryption key R with which to encrypt any additional messages to be transferred to the secure device. Helper string P preferably contains private time base Tₚ, secure sketch output s, and hash function output H1(K1,H0(W),T). Encryption key R may be, for instance, hash function output H2(K2,H0(W),T).

The security server 102 uses encryption key R to encrypt any additional messages to be transferred to the secure device 104. The security server 102 provides, at step S1610, notice of successful user identity and access verification to the app on the user terminal 104. The security server 102 also transfers, at step S1610, the additional messages along with helper string P to the user terminal 104. The messages and helper string P may be further end-to-end encrypted from the security server 102 to the user terminal 104.

If the verification of the user's identity and right is unsuccessful, at step S1606, the security server 102 provides, at step S1612, notice of unsuccessful user identity or access verification to the app 120 on the user terminal 104. The security server 102 may take other security related steps, at step S1614, such as notifying security personnel of an attempted unauthorized access to the secure device 104.

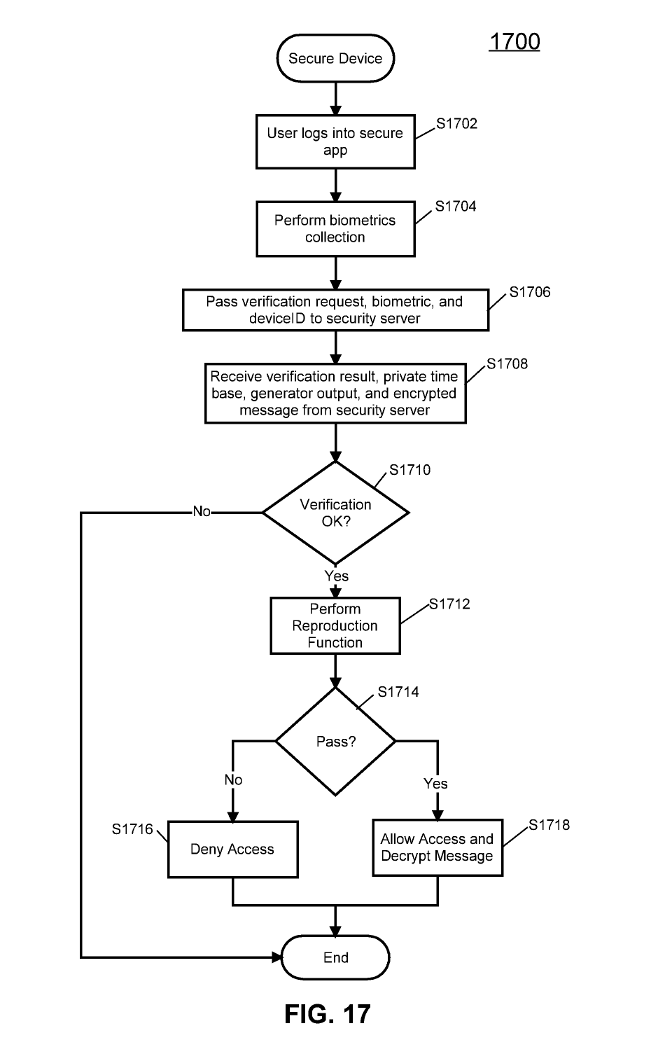

FIG. 17 depicts a flowchart 1700 for a secure device such as user terminal 104. One skilled in the art would understand that the transfer of information between devices may be encrypted to further enhance security, some operations may be optional, and that the order of some operations may be changed.

In an embodiment, the user terminal 104 hosts a secure app, such as app 120, that is designed to facilitate the method for accessing the device. The user logs in, at S1702, to the secure app 120, allowing local authentication on the user terminal 104 of the user's right to start the process. Login may be via password, or other well-known methods. Alternatively, login may involve communication with the security server 102 to verify user and/or device credentials. The user performs, at step S1704, a local biometric collection on the smart phone 104 for identity verification with the security server 102, for instance as described in U.S. patent application Ser. No. 13/743,149, cited above. One skilled in the art would understand that the login and biometric authentication steps at the user terminal 104 may be combined in various forms or omitted. Different means of authentication may be used in step S1704, for example, password, PIN, security question, etc. One skilled in the art would understand that if any local biometric is collected at step S1704 for authentication purposes, this biometric should not be the same form of biometric as used in the reproduction function (e.g., they should not both be fingerprints).

The user terminal 104 passes, at step S1706, the user identity verification request, user terminal collected authentication data, and the device ID to the security server 102. The user terminal 104 receives the user identity verification results from the security server 102. If unsuccessful, at step S1710, the actions terminate. If successful, at step S1710, the user terminal 104 also receives, at step S1708, the private time base, fuzzy extractor generator function output helper string P, and any messages encrypted using fuzzy extractor generator function output key R. These may be further encrypted end-to-end between the security server 102 and the user terminal 104.

The secure device 104 collects a local biometric sample and uses the local biometric sample with the helper string P to perform, at step S1712, the fuzzy extractor reproduction function. If the hash function output used for verifying access rights generated by the reproduction function does not match the version received from the security served, at step S1714, access is denied, at step S1716. If it does match, at step S1714, access is granted, at step S1718, and any messages encrypted using the biometric generated key R are decrypted.

System Event Flow where the User Terminal is an Intermediary Device

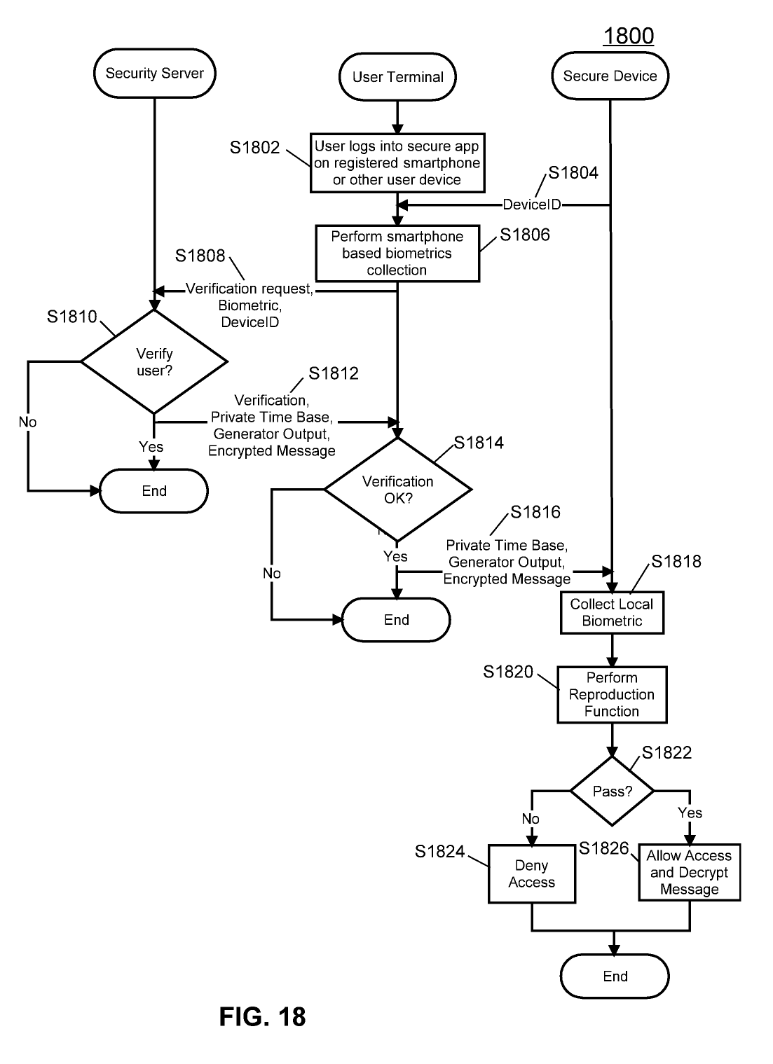

FIG. 18 shows the flow of events and interactions between a secure device 106, user terminal 104, and security server 102 during verification of a user in an embodiment. The order of events is for example purposes only and one skilled in the art would understand which events may be reversed or otherwise rearranged in order. One skilled in the art would understand that the transfer of information between devices may be encrypted to further enhance security.

The events are initiated by the user's desire to access a secure device 106. In this embodiment, the secure device 106 is independent of user terminal 104 and user terminal 104 acts as an intermediary between secure server 102 and secure device 106. The user may log into, at step S1802, a secure application (app), such as App 120, on a registered smartphone or other user device, such as user terminal 104. The user may retrieve, at step S1804, the device ID from the secure device 106, for instance by tapping the secure device 106 with an NFC enabled smartphone, using short range communication module 206 in the user terminal 104 and short range communication module 312 in the secure device 106. The user may perform, at step S1806, a biometrics based biometric sample collection on the user terminal 104, for instance using camera 212 and user interface 208 as described above and in co-pending U.S. patent application Ser. No. 13/743,149. In an embodiment, the biometric is used in lieu of a login to the secure app. In an embodiment the login credentials are used in lieu of the user terminal collected biometric sample.

A verification request along with verification information, e.g., biometric collected on user terminal, login credentials, or both, is transferred, at step S1808, to the security server 102, for instance via cellular communications, along with the collected device ID of the secure device 106. The security server 102 performs a verification of the user and returns the results. If the security server's verification of the user, at step S1810, is unsuccessful the activity terminates. If the security server's verification of the user is successful, at step S1810, the security server 102 performs the post-enrollment (i.e., verification stage) portion of the generator function and also returns to the user terminal 104, at step S1812, the helper string P, containing for instance private time base Tₚ, secure sketch output s, and the output of hash function H1 where s and the output of H1 are based upon a previously obtained biometric sample of the user. If the security server's verification of the user is successful, at step S1810, the security server 102 may also return, at step S18112, one or more message encrypted using string R, the output of hash function H2 based upon a previously obtained biometric sample of the user.

If the verification by the security server 102 was successful, at step S1814, the user terminal 104 passes, at step S1816, helper string P along with any messages encrypted using key R to the secure device 106, for instance by tapping the secure device 106 with an NFC enabled smartphone (i.e. user terminal 104), using short range communication module 206 in the user terminal 104 and short range communication module 312 in the secure device 106. The secure device 106 collects, at step S1818, a local biometric, for instance using biometric sampler 308, possibly aided by user interface 306. The secure device 106 performs, at step S1820, the reproduction function to determine if the locally collected biometric is sufficiently close to the original biometric used by the security server 102 to recover the original biometric and, therefore, to recover key R. If it is not sufficiently close, at step S1822, access to the secure device 106 is denied, at step S1824, or some number of retries is initiated. If it is sufficiently close, at step S1822, access to the secure device is allowed, at step S1826, and any accompanying messages encrypted with key R are decrypted.

Device Flow Charts

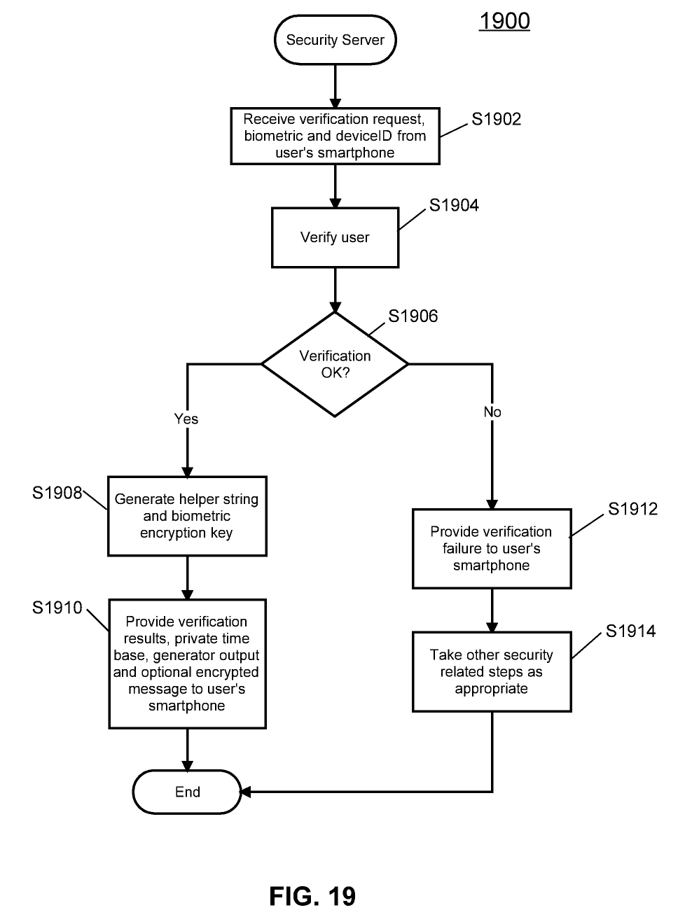

FIG. 19 depicts the verification stage flowchart 1900 for a security server such as security server 102. One skilled in the art would understand that the transfer of information between devices may be encrypted to further enhance security, some operations may be optional, and that the order of some operations may be changed.

The security server 102 receives, at step S1902, for instance via cellular communications, a verification request including a biometric, user login credentials, or both from a user terminal 104. Additionally, the security server 102 receives, at step S1902, an identifier of a device 106 the user wishes to access. The security server 102 uses, at step S1904, the information received with the verification request to verify the user's identity and to verify that the user has rights to access the requested secure device 106.

If the verification of the user's identity and right is successful, at step S1906, the security server 102 performs, at step S1908, the verification portion of a robust fuzzy extractor generator function as described above, based on a previously collected biometric B of the user compatible with the capabilities of the requested secure device, generating helper string P and generating an encryption key R with which to encrypt any additional messages to be transferred to the secure device. Helper string P preferably contains private time base Tₚ, secure sketch output s, and hash function output H1(K1,H0(W),T). Encryption key R may be, for instance, hash function output H2(K2,H0(W),T).

The security server 102 uses encryption key R to encrypt any additional messages to be transferred to the secure device. The security server 102 provides, at step S1910, notice of successful user identity and access verification to the app 120 on the user terminal 104. The security server 102 also transfers, at step S1910, the additional messages along with helper string P to the user terminal 104 for further transfer to the secure device 106. The messages and helper string P may be further end-to-end encrypted from the security server 102 to the secure device 106 such that the user terminal 104 cannot read them.

If the verification of the user's identity and right is unsuccessful, at step S1906, the server 102 provides, at step S1912, notice of unsuccessful user identity or access verification to the app 120 on the user terminal 104. The security server 102 may take, at step S1914, other security related steps such as notifying security personnel of an attempted unauthorized access to the secure device 106.

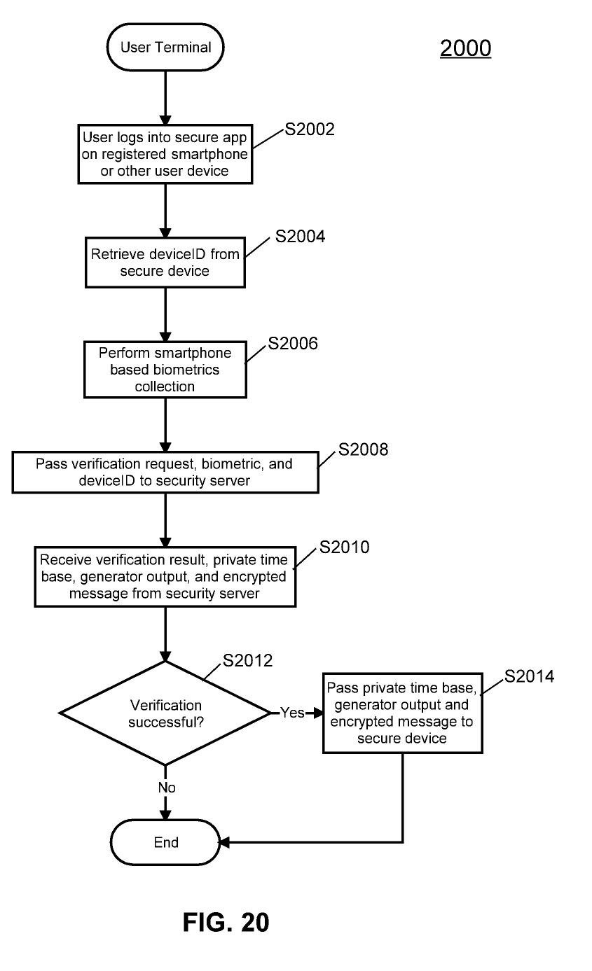

FIG. 20 depicts an example flowchart 2000 for a user terminal such as user terminal 104. One skilled in the art would understand that the transfer of information between devices may be encrypted to further enhance security, some operations may be optional, and that the order of some operations may be changed.

In an embodiment, the user terminal 104 hosts a secure app such as App 120 that is designed to facilitate the method for accessing the secure device 106. The user logs in to the secure app 120, at step S2002, allowing local authentication on the user terminal 104 of the user's right to start the process. Login may be via password, or other well-known methods. Alternatively, login may involve communication with the security server to verify user and/or device credentials. The user locates the user terminal 104 in sufficiently close proximity (e.g., 10 centimeters for NFC) to the secure device 106 to allow retrieval, at step S2004, of the device ID of the secure device 106 or a secure form of its device ID (e.g. hash). The user performs, at step S2006, a local biometric collection on the smart phone 104 for identity verification with the security server 102, for instance as described in U.S. patent application Ser. No. 13/743,149, cited above. One skilled in the art would understand that the login and biometric authentication steps at the user terminal 104 may be combined in various forms or omitted.

The user terminal 104 passes, at step S2008, the user identity verification request, user terminal collected biometric data, and the device ID of the secure device 106 to the security server 104. The user terminal 104 receives, at step S2010, the user identity verification results from the security server 102. If verification is unsuccessful, at step S2012, the actions terminate. If verification is successful, at step S2012, the user terminal 104 also receives, at step S2010, the information to pass to the secure device, such as private time base, fuzzy extractor generator function output helper string P, and any messages encrypted using fuzzy extractor generator function output key R. These may be further encrypted end-to-end between the security server 102 and the secure device 106 such that they are unreadable to the user terminal 104. The user places the user terminal 104 sufficiently close to the secure device 106 and information directed to the secure device 106 is transferred, at step S2014, from the user terminal 104.

The app 120 on the user terminal 104 may act as a further user interface to the secure device 106 or further interaction may be via a user interface 306 which is a part of the secure device 106. For instance, a user interface may prompt the user to retry the local biometric collection. Additionally, if the secure device 106 is a computer with access to storage, the user interface may allow the recall and display of data from storage.

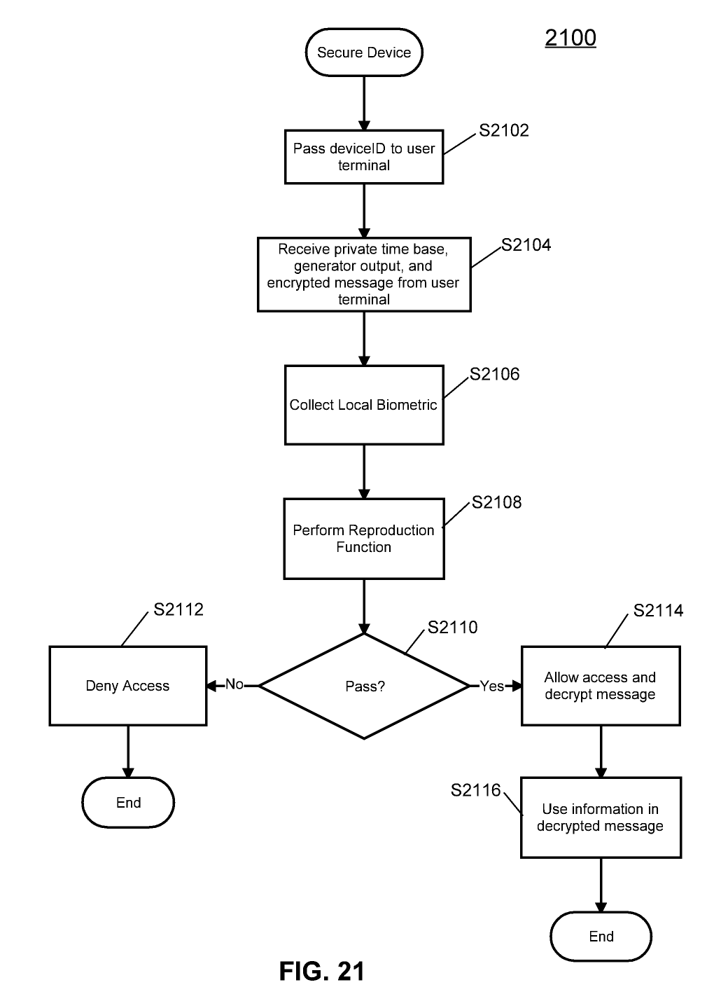

FIG. 21 depicts an example flowchart 2100 for a secure device such as secure device 106. One skilled in the art would understand that the transfer of information between devices may be encrypted to further enhance security, some operations may be optional, and that the order of some operations may be changed.

When the user terminal 104 is sufficiently close to the secure device 106 they establish communications, for instance via NFC or BLE, and the secure device 106 transfers, at step S2102, its device ID or a hash or other function of its device ID to the user terminal 104. The secure device 106 then awaits further interaction with the user terminal 104.

The secure device 106 receives, at step S2104, information from the security server 102 via the user terminal 104. In an embodiment, this information contains fuzzy extractor generator function output helper string P and any messages encrypted using fuzzy extractor generator function output key R. In an embodiment, the helper string P contains a private time base, the secure sketch output, and the hash function output used for verifying access rights. These may be encrypted end to end between the security server 102 and the secure device 106 such that they are unreadable to the user terminal 104.

The secure device 106 performs, at step S2106, a local collection of a biometric, such as fingerprint or iris scan, from the user. The secure device 106 uses this local biometric sample and the helper string P to perform, at step S2110 the fuzzy extractor reproduction function. If the hash function output used for verifying access rights generated by the reproduction function does not match the version received from the security server 102, at step S2110, access is denied at step S2112. If the hash function output does match, at step S2110, access is granted and any messages encrypted using the biometric generated key R are decrypted at step S2114. These messages may contain information such as level of access, for instance which drawers in a safe may unlock if the secure device 106 is a safe. If the secure device 106 is an access badges creator, the messages may be used to program a SIM card or magnetic strip in a badge that allows further access in a secure facility. If simple yes/no binary access is all that is necessary, the encrypted messages and the hash function for creating key R may be omitted.

Example Use Cases

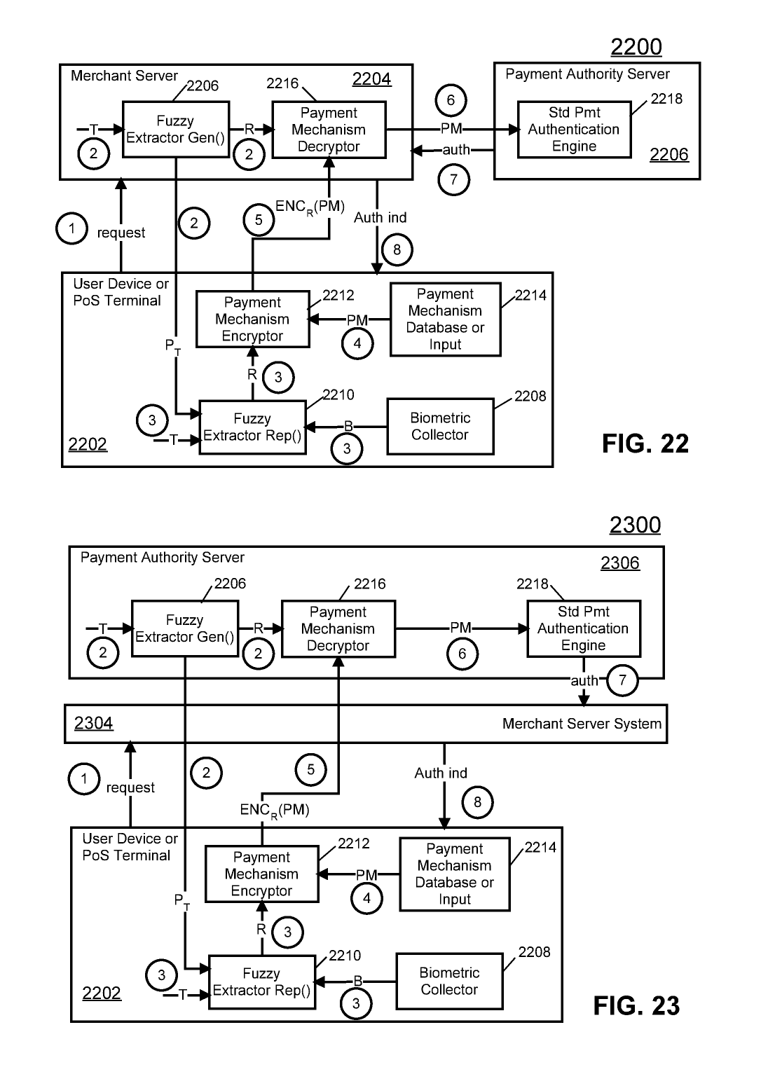

FIGS. 22 through 26 describe example use cases and devices for applying the one-time robust fuzzy extractors that are described above. The use cases described herein concentrate on Internet/mobile financial transactions, Internet/mobile banking, and the use of point of sale (PoS) terminals, but the concepts and methods described herein are not limited to such fields and uses.

The example use case scenarios are described as the actions performed by functional components of devices in a system interacting to achieve transactions secured by biometric generated one-time keys. One skilled in the art would understand the functional flow of each device described in from these system diagrams. One of skill in the art would understand how these scenarios are derived from a generic scenario of a user device (e.g., user terminal 104) interacting with a financial system, with an optional merchant system relaying transactions.

In FIG. 22, a system 2200 and ordered set of interactions are depicted that use biometrics to authorize and encrypt transactions in an Internet/mobile banking scenario. In this scenario, the user initiates a transaction on a user device 2200 (such as user terminal 104). The user device 2200 could be for instance a laptop or a smartphone like the SAMSUNG GALAXY S5™ or the APPLE IPHONE 5S™, among others. The user is authenticated with a secure merchant server 2204 and at least the payment portion of the transaction is encrypted using an encryption key generated from the user's biometric. The secure merchant server 2204 interacts with a payment authority server 2206 (e.g., Visa, PayPal, or their clearing house) as is currently done for online payment verification.

FIG. 22 has the interactions between devices and modules numbered to allow for easy discussion of the flow of events.

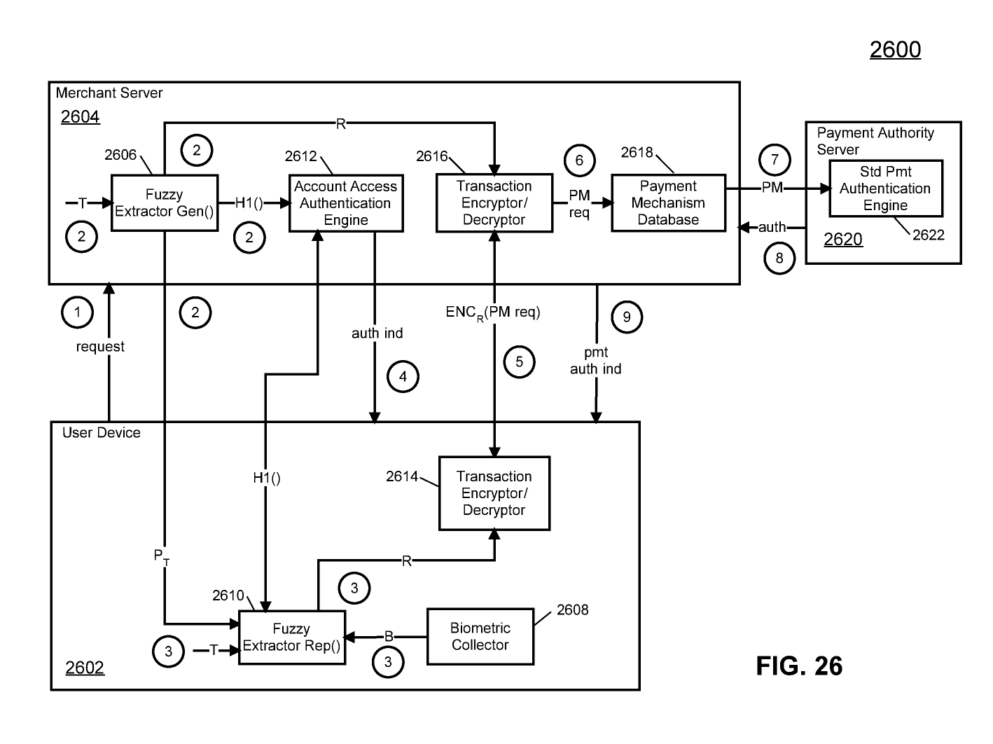

At step \textcircled{1}, the user device 2202 makes a request to the merchant server 2204. This request may be, for instance, an initial login to the merchant server 2204 (e.g., AMAZON.COM™, STAPLES.COM™) or may be a step in the payment process such as a request to checkout. In FIG. 22, this request gates access to secure payment processing. However, the request may also gate access to other merchant server functions such as accessing account features such as gift card balances, backup security questions, or securely entering or accessing payment methods that may be stored by the merchant server 2204 as will be described with respect to FIG. 26 below. If the initial login request is refused, this step may gate access to all benefits of an account the user has with the merchant server 2204. One skilled in the art would understand that the word “payment” in modules names (e.g. payment mechanism encryptor 2212) is for simplicity in explaining an example transaction and should not be seen as a limitation of the functionality of the module to be used for other secure transactions.

At step \textcircled{2}, the verification stage of the fuzzy extractor Gen( ) module 2206, and the corresponding verification stage of the secure sketch module, of the merchant server 2204 retrieves secure information, such as C, Z, and H0( ), from non-volatile storage.

In an aspect, the fuzzy extractor Gen( ) module 2206 uses time as an input in step \textcircled{2}, for instance to reorder Z into Zu or as input to hash functions H1( ) and H2( ), to make the output of the fuzzy extractor one-time to reduce susceptibility of the system to replay attacks as described above. Time T may be a function of any time known to both the user device 2202 and the merchant server 2204 and sufficiently synchronized between the two. Examples include Universal Time, local time in the user's time zone or the merchant server's time zone, or a private time base as previously described. Based on the inputs, the fuzzy extractor Gen( ) module 2206 generates R, a biometrics based encryption key to be used in encrypting secure transactions between the user device 2202 and the merchant server 2204 during the current login session. The encryption key R is not transferred to the user device 2202. The fuzzy extractor Gen( ) module 2206 also generates P_{T}. P_{T} is passed to the user device 2202 and contains sufficient information for the user device 2202 to verify the user is authorized and to generate a local copy of R for use in encrypted transactions with the merchant server 2204. In an aspect, P_{T} contains private time base T_{P}, authentication string H1( ), and secure sketch output s.

One skilled in the art would understand based on the descriptions herein how to perform an enrollment stage that would allow the secure information to be saved while protecting the user's privacy and minimizing any security risk due to a breach of the merchant server's non-volatile storage. However, the fuzzy extractor Gen( ) module 2206 enrollment functionality may be split between the merchant server 2204 and the user device 2202 so that the user does not need direct physical access to the merchant server 2204 to provide a biometric. For instance, the user device 2202 may collect the enrollment biometric and pass the biometric to the merchant server 2204 via secure communications, such as well-known public/private key mechanisms. Alternatively, the user device 2202 may perform the entire enrollment stage and pass the results to the merchant server 2204 for storage, eliminating the need for the merchant server 2204 to ever have the user's biometric. In both cases, the user device 2202 should not store the enrollment biometric or any results of the enrollment stage of the fuzzy extractor Gen( ) module 2206 functionality.

In step \textcircled{3}, the biometric collector 2208 in the user device 2202 collects a biometric sample B, such as a fingerprint, and processes the biometric sample to the desired form, for example, a six hundred forty (640) byte FingerCode aligned to the core of the fingerprint. The fuzzy extractor Rep( ) module 2210 uses the biometric B along with secure sketch output S from P_{T} to create its own local copy of H1( ). If the local copy of H1( ) matches the copy of H1( ) from the merchant server 2204 in P_{T}, then the user device 2202 has succeeded in authenticating the merchant server 2204 and verifying the user. In an aspect, the fuzzy extractor Rep( ) module 2210 uses time as an input, for instance a function of T_{P} from P_{T}. If the local copy of H1( ) does not match copy of H1( ) from the merchant server 2204, the user device 2202 may retry with T−1 or T+1 in case the two devices are slightly out of time synch. If the local copy of H1( ) matches the copy of H1( ) from the merchant server 2204, then fuzzy extractor Rep( ) module 2210 generates a local version of R. The user and the user device 2202 are authenticated to the merchant server 2204 if encrypted communications using the copies of R generated on each side are successful. For instance, if messages encrypted with R are exchanged, integrity checks (e.g., CRC checks) are successful, and the messages make sense, then the local version of R must match the server's version of R, authenticating the user and the user device 2202 to the merchant server 2204.

In step \textcircled{4}, the user device 2202 prepares a secure transaction with the merchant server 2204 with the transaction encrypted by payment mechanism encryptor 2212 using the copy of R generated at the user device 2202. For instance, the user device 2202 may be transferring a payment mechanism PM, such as credit card information, PAYPAL™ account information, a mobile phone account, an electronic wallet, or banking account information. Other information may be transferred along with the payment mechanism such as the currency used (e.g., US dollar, Euro, etc.) and the authorized amount of the transaction. Payment mechanism database or input 2214 may contain non-volatile storage, such as a SIM card, for such information or may be an input device such as a keyboard or touchscreen for entering such information. In an aspect, payment mechanism database or input 2214 is an externally connected device such an externally connected credit card reader. One skilled in the art would understand that the term “database” can mean any form of storing the data such as fields in a record, dedicated memory locations, local variables accessed by software or hardware, registers, a file, a structured database, an unstructured database, etc.

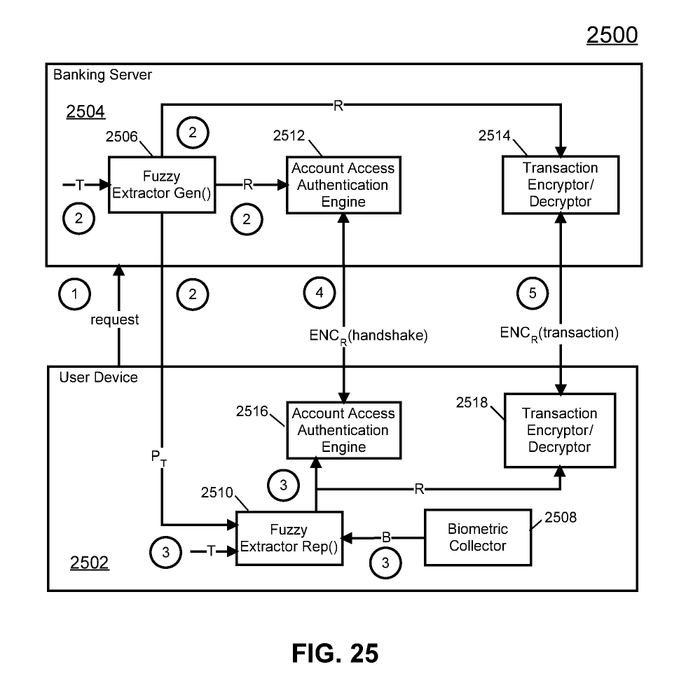

In step \textcircled{5}, the secure transaction is performed, such as transferring payment mechanism PM, encrypted with R, from payment mechanism encryptor 2212 in the user device 2202 to payment mechanism decryptor 2216 in the merchant server 2204. Even though FIG. 22 illustrates encrypted communications going in only one direction, that depiction is for clarity of the example scenario only. Both the user device 2202 and the merchant server 2204 may have transaction encryptor/decryptors 2212, 2216, as will be discussed in FIGS. 25 and 26, allowing two-way communications encrypted using R. If a transaction spans more than a predetermined time, a new version of R based on incremented time function T may be generated on both sides of the communication path.

One skilled in the art would understand that communication encrypted using R may additionally be transferred over a secure link using any one of many well-known security mechanisms.

At steps \textcircled{6} and \textcircled{7}, the merchant server 2204 interacts with a payment authority server 2218, such as PAYPAL™, a bank, or credit card companies such as VISA™ or MASTERCARD™ using standard mechanisms as are used today for online shopping transaction. At step \textcircled{8}, an indication that the payment was authorized (or denied) by the payment authority server 2218 is provided to the user device 2202. One skilled in the art would understand that this indication may be encrypted using R or may be transferred without such encryption.

In an alternate embodiment (not shown), the user device 2202 is replaced by a Point-of-Sale (PoS) terminal. The PoS terminal is similar to the user device 2202. In an aspect, the PoS terminal incorporates a built-in card reader. One skilled in the art would understand that a PoS terminal may incorporate more or fewer of the features of a smartphone. In the PoS terminal, a payment mechanism collector replaces the payment mechanism database or input 2214 of the user device. Since the user does not own or otherwise control the PoS terminal, the PoS terminal does not store any information about user payment mechanisms, but exchanges them on a per transaction basis via, for instance, a card reader. The PoS terminal may be controlled by the same entity as the merchant server 2204. In an aspect, the PoS terminal may be a wired device such as a cash register with an attached credit card reader. In an aspect, the PoS terminal may be a wireless terminal that communicates with the merchant server 2204 wirelessly, such as over Wi-Fi or cellular.

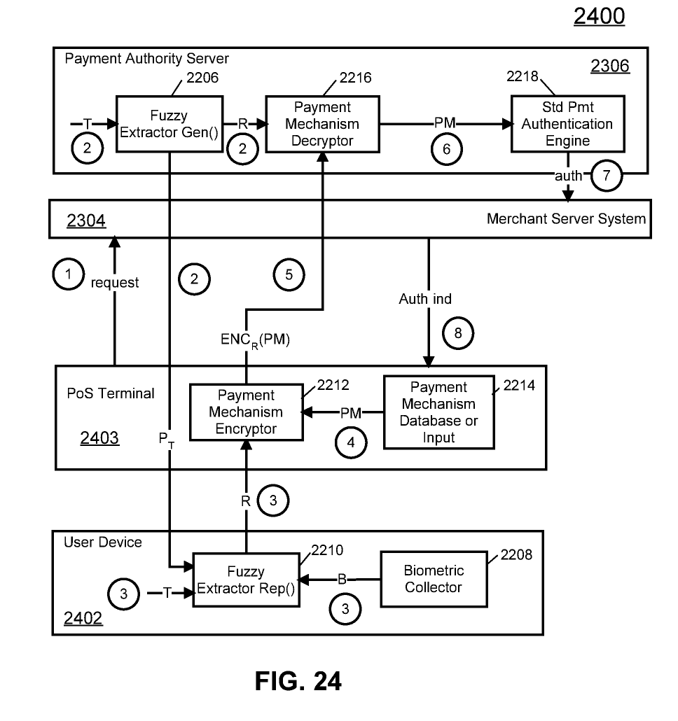

Since the user does not control the PoS terminal, the PoS terminal may not be involved in the enrollment phase. Enrollment may happen via a side mechanism such as an initial enrollment with the merchant via the Internet, or at a physical place of enrollment. It may be impractical to directly enroll with all possible merchants using PoS terminals. FIG. 24, presented later, will mitigate this issue for the PoS case.

FIG. 23 shows a system 2300 where the user is verified directly with the payment authority. This scenario has the same basic transactions as that in FIG. 22 except the fuzzy extractor Gen( ) module 2206 and the payment mechanism decryptor 2216 are resident in the payment authority server 2306 instead of the merchant server 2304. The merchant server system 2304, which may include a PoS terminal to relay information from the user device 2202 (e.g., via NFC or BLE), relays communications between the user device 2202 and the payment authority server 2306. This allows the user to be enrolled with only the payment authorities (bank, PAYPAL™, etc.) rather than a variety of merchants. In step \textcircled{7}, the merchant server 2304 is informed of the authorization or denial of the transaction. In step \textcircled{8}, this authorization indication is forwarded to the user device 2202.

The scenarios depicted in FIGS. 22 and 23 are not mutually exclusive. For instance, the merchant may use aspects of FIG. 22 for user login, gift card balance access, or for access to payment authorities not practicing FIG. 23 while simultaneously supporting FIG. 23 for payment authorities practicing FIG. 23. In addition, the system of FIG. 23 may use a PoS terminal in place of the user device 2202 in a similar manner as described in relation to FIG. 22.

The system 2300 in FIG. 23 may be modified for use with a user device 2402 and a PoS terminal 2404, as shown in FIG. 24, with the fuzzy extractor Rep( ) 2210 and the biometrics collection functionality 2208 in the user device 2402 and the payment mechanism collection 2204 and the payment encryption functionality 2212 on the PoS terminal 2403. In an aspect, the PoS terminal 2403 and the user device 2402 communicate via NFC or BLE. The one-time encryption key is passed from the user device 2402 to the PoS terminal 2403 for use during the one transaction. One skilled in the art would understand that more or less functionality may be in the PoS terminal 2403, the merchant server system 2304, or the user device 2403.

FIG. 25 shows a system 2500 using some of the aspects described above for interacting with a banking server 2504, for instance, for conducting secure, biometric enabled, online or mobile banking.

In step \textcircled{1}, a request is made from a user device 2502 to a banking server 2504. This request may be in the form of an initial login that states who the user claims to be or indicates the account the user wishes to access.

At step \textcircled{2}, the verification stage of the fuzzy extractor Gen( ) module 2506, and the corresponding verification stage of the secure sketch module, of the banking server 2504 retrieves secure information, such as C, Z, and H0( ), from non-volatile storage. In an aspect, the fuzzy extractor Gen( ) module 2506 uses time as an input as was described with respect to FIG. 22.

Based on the retrieved inputs and time, the fuzzy extractor Gen( ) module 2506 generates R, a biometrics based encryption key to be used in encrypting secure transactions between the user device 2502 and the banking server 2504 during the current banking session. The encryption key R is not transferred to the user device 2502, but is passed to the account access authentication engine 2512 and the transaction encryptor/decryptor 2514 in the banking server 2504. The fuzzy extractor Gen( ) module 2506 also generates P_{T}. P_{T} is passed to the user device 2502 and contains sufficient information for the user device 2502 to verify the user is authorized and to generate a local copy of R for use in encrypted transactions with the banking server 2504. In an aspect, P_{T} contains private time base T_{P}, authentication string H1( ), and secure sketch output S.

At step \textcircled{3}, the Biometric Collection Module in the User Device collects a biometric sample B, such as a fingerprint, and processes it to the desired form, for example, a 640 byte FingerCode aligned to the core of the fingerprint. The Fuzzy Extractor Rep( ) Module uses the biometric B along with secure sketch output S from P_{T} to create its own local copy of H1( ). If the local copy of H1( ) matches the copy of H1( ) from the Banking Server in P_{T}, then the User Device has succeeded in authenticating the Banking Server and verifying the user. In an aspect, the Fuzzy Extractor Rep( ) Module uses time as an input, for instance a function of T_{P} from P_{T}. If the local copy of H1( ) does not match copy of H1( ) from the Banking Server, the User Device may retry with T−1 or T+1 in case the two devices are slightly out of time synch.

If the local copy of H1( ) matches the copy of H1( ) from the banking server 2504, then fuzzy extractor Rep( ) module 2510 generates a local version of R. This local copy of R is passed to the account access authentication engine 2516 and the transaction encryptor/decryptor 2518 in the user device 2502.

If the account being accessed has multiple persons authorized for access, the fuzzy extractor Gen( ) module 2506 may create an instance of R and of P_{T} for each authorized user. Fuzzy extractor Rep( ) module 2510 may then compare locally generated H1( ) to the set of H1( ) contained in P_{T}. If one matches, the banking server 2504 is authenticated to the user device 2502.

At step \textcircled{4}, the account access authentication engine 2516 in the user device 2502 and the account access authentication engine 2512 in the banking server 2504 perform a handshake encrypted using their local copies of R. If the account being accessed has multiple persons authorized for access, the account access authentication engine 2512 in the banking server 2504 may attempt decryption of a handshake message from the user device 2502 with R for a first authorized user. If this fails, the account access authentication engine 2512 in the banking server 2504 may attempt decryption with R for a subsequent authorized user. If decryption of the handshake message is successful with one of the R, then the user is authenticated by, and possibly identified by, the banking server 2504 and the scenario progresses using the encryption key R generated for that authorized user.

At step \textcircled{5}, banking transactions, encrypted using R, are performed between the transaction encryptor/decryptor 2518 in the user device 2502 and the transaction encryptor/decryptor 2514 in the banking server 2504. If the banking session lasts longer than a predetermined time, R may need to be regenerated on each side using a new T.

FIG. 26 shows a system 2600 which combines aspects described in FIGS. 22 and 25 and illustrates additional aspects.

This scenario starts with a request at step \textcircled{1}. At step \textcircled{2}, fuzzy extractor Gen( ) module 2606 of the merchant server 2604 generates helper string P_{T}, encryption key R, and hash function output H1( ) but H1( ) is not included in P_{T}. For instance, if the user device 2602 is not trusted P_{T} may not include H1( ) and the version of H1( ) generated local to the user device 2602 from local biometric B in step \textcircled{3} is sent from fuzzy extractor Rep( ) 2610 back to fuzzy extractor Gen( ) 2606 to see if it matches. If H1( ) is sent back from fuzzy extractor Rep( ) 2610, it should be one-time otherwise it could be captured and used for replay to foil at least the authentication steps. If H1( ) from fuzzy extractor Rep( ) 2610 doesn't match H1( ) from fuzzy extractor Gen( ) 2606, R will not be the same on both sides and decryption will fail.

At step \textcircled{4}, the account access authentication engine 2612 compares H1( ) generated by the merchant server 2604 with H1( ) generated by the user device 2602 and provides an authorization indication communicating whether authorization succeeded or failed. If authorization succeeded, the user device 2602 and merchant server 2604 use their respective copies of encryption key R in their respective transaction encryptor/decryptors 2614, 2616 to perform secure communications in step \textcircled{5}. This may include, for instance, merchant server functions such as accessing gift card balances, backup security questions, or securely entering payment methods from the user device or accessing payment methods that may be stored by the merchant server 2604 in an optional payment mechanism database 2618. In an aspect, a payment mechanism PM is requested in step \textcircled{6} to be retrieved from a payment mechanism database 2618 stored in the merchant server 2604 or accessed by the merchant server 2604. In step \textcircled{7}, the payment mechanism is communicated to a payment authority server 2620 via conventional means. In an alternate aspect, the user device 2602 specifies the payment mechanism fully, and step \textcircled{6} and the payment mechanism database 2618 are unnecessary. In an aspect, the payment mechanism database 2618 is temporary storage of a payment mechanism specified by the user device 2602 for use during a specific transaction, and is erased after the transaction completes. In step \textcircled{8}, the merchant server 2604 receives authorization or denial of the payment which is then indicated to the user device 2602 in step \textcircled{9}.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method of operating a biometric security server to exchange encrypted information with a secure device comprising:
enrolling a user with the biometric security server, the enrollment comprising:
collecting at least one biometric sample of the user,
transforming the at least one biometric sample to create a transformed enrollment biometric using a one way function, and
storing the transformed enrollment biometric;
receiving, from the secure device, a request to exchange information encrypted based on the at least one biometric sample of the user;
generating a secure sketch output from the transformed enrollment biometric, the secure sketch output comprising a measurement difference encoding portion and an error correction encoding portion; and
transmitting, to the secure device, the secure sketch output.

2. The method of claim 1, wherein the secure sketch output is generated in response to receiving the request to exchange information, and wherein the method further comprises:
transforming the transformed enrollment biometric as a function of time to create a time-based transformed enrollment biometric; and
using the time-based transformed enrollment biometric as an input to a secure sketch.

3. (canceled)

4. (canceled)

5. (canceled)

6. (canceled)

7. (canceled)

8. (canceled)

9. The method of claim 1, wherein the transformed enrollment biometric is a subset of a fingercode, the subset of the fingercode being chosen as a function of time.

10. (canceled)

11. (canceled)

12. (canceled)

13. (canceled)

14. (canceled)

15. The method of claim 9, wherein the fingercode comprises 512 nine bit values.

16. (canceled)

17. (canceled)

18. The method of claim 1, wherein the at least one biometric sample comprises a multiplicity of biometric samples, transforming the at least one biometric sample into the transformed enrollment biometric comprises:
transforming the multiplicity of biometric samples into a multiplicity of fingercodes;
using each fingercode of the multiplicity of fingercodes as a secure sketch input to generate a secure sketch output for each fingercode, the secure sketch output comprising a measurement difference encoding portion and an error correction encoding portion;
using the measurement difference encoding portion derived from each fingercode of the multiplicity of fingercodes as a secure sketch input to a measurement difference resolution decoder to resolve measurement differences of each remaining fingercode;
using the error correction encoding portion derived from each fingercode of the multiplicity of fingercodes as the secure sketch input to an error correction code decoder to correct errors for each remaining fingercode;
determining, for each fingercode of the multiplicity of fingercodes, a number of errors corrected; and
selecting the fingercode for which a fewest number of corrections is determined as the transformed enrollment biometric.

19. (canceled)

20. The method of claim 1, wherein the transformed enrollment biometric is a fingercode having a plurality of values, and the measurement difference encoding portion of the secure sketch output contains a number of least significant bits of each value of the fingercode.

21. (canceled)

22. (canceled)

23. (canceled)

24. (canceled)

25. The method of claim 1, further comprising:
generating an encryption key from the transformed enrollment biometric;
encrypting a message using the encryption key; and
transmitting the encrypted message to the secure device.

26. A biometric security server for exchanging encrypted information with a secure device comprising:
a communication interface that:
receives, from the secure device, a request to exchange information encrypted based on at least one biometric sample of a user, and
transmits, to the secure device, a secure sketch output; and
a processor communicatively coupled with the communication interface, the processor configured to:
enroll the user with the biometric security server, the enrollment comprising:
collecting at least one biometric sample of the user,
transforming the at least one biometric sample to create a transformed enrollment biometric using a one way function, and
storing the transformed enrollment biometric; and
generate a secure sketch output from the transformed enrollment biometric, the secure sketch output comprising a measurement difference encoding portion and an error correction encoding portion.

27. The biometric security server of claim 26, wherein the processor generates the secure sketch output in response to receiving the request to exchange information and wherein the processor is further configured to:
transform the transformed enrollment biometric as a function of time to create a time-based transformed enrollment biometric; and
use the time-based transformed enrollment biometric as an input to a secure sketch.

28. (canceled)

29. (canceled)

30. (canceled)

31. (canceled)

32. (canceled)

33. (canceled)

34. The biometric security server of claim 26, wherein the transformed enrollment biometric is a subset of a fingercode, the subset of the fingercode being chosen as a function of time.

35. (canceled)

36. (canceled)

37. (canceled)

38. (canceled)

39. (canceled)

40. The biometric security server of claim 34, wherein the fingercode comprises 512 nine bit values.

41. (canceled)

42. (canceled)

43. The biometric security server of claim 26, wherein the at least one biometric sample comprises a multiplicity of biometric samples, the processor transforms the at least one biometric sample into the transformed enrollment biometric by:
transforming the multiplicity of biometric samples into a multiplicity of fingercodes;
using each fingercode of the multiplicity of fingercodes as a secure sketch input to generate a secure sketch output for each fingercode, the secure sketch output comprising a measurement difference encoding portion and an error correction encoding portion;
using the measurement difference encoding portion derived from each fingercode of the multiplicity of fingercodes as a secure sketch input to a measurement difference resolution decoder to resolve measurement differences of each remaining fingercode;
using the error correction encoding portion derived from each fingercode of the multiplicity of fingercodes as the secure sketch input to an error correction code decoder to correct errors for each remaining fingercode;
determining, for each fingercode of the multiplicity of fingercodes, a number of errors corrected; and
selecting the fingercode for which a fewest number of corrections is determined as the transformed enrollment biometric.

44. (canceled)

45. The biometric security server of claim 26, wherein the transformed enrollment biometric is a fingercode having a plurality of values, and the measurement difference encoding portion of the secure sketch output contains a number of least significant bits of each value of the fingercode.

46. (canceled)

47. (canceled)

48. (canceled)

49. (canceled)

50. The biometric security server of claim 26, wherein:
the processor is further configured to:
generate an encryption key from the transformed enrollment biometric, and
encrypt a message using the encryption key; and
the communication interface further transmits the encrypted message to the secure device.

51. A method of verifying a biometric identifier comprising:
receiving, from a biometric security server, a secure sketch output, the secure sketch output derived from an enrollment biometric sample;
collecting at least one local biometric sample; and
processing the at least one local biometric sample by:
transforming the at least one local biometric sample to create a transformed biometric using a one way function,
decoding the transformed biometric to resolve measurement differences with a measurement difference resolution decoder using the secure sketch output to create at least one decoded local biometric sample,
correcting errors in the at least one decoded local biometric sample using an error correction code decoder to determine an amount of corrected errors and create an estimated local biometric sample, and
if the amount of corrected errors is less than a first pre-determined threshold confirming a positive match.

52. The method of claim 51, further comprising:
responsive to confirming a positive match, generating an encryption key; and
responsive to confirming a positive match, allowing access to a process of exchanging encrypted data.

53. (canceled)

54. (canceled)

55. The method of claim 51, further comprising:
setting a possible match counter and an attempts counter;
if the amount of corrected errors is greater than the first pre-determined threshold, determining whether the amount of corrected errors is less than a second pre-determined threshold; and
if the amount of corrected errors is less than a second pre-determined threshold:
incrementing the possible match counter; and
determining whether the possible match counter is greater than a third pre-determined threshold; and
if the possible match counter is greater than the third pre-determined threshold, confirming a positive match.

56. The method of claim 55, further comprising:
responsive to confirming a positive match, generating an encryption key; and
responsive to confirming a positive match, allowing access to a process of exchanging encrypted data.

57. (canceled)

58. (canceled)

59. (canceled)

60. (canceled)

61. (canceled)

62. (canceled)

63. (canceled)

64. The method of claim 51, further comprising:
receiving, from the biometric security server, an access control hash value;
performing a hash function on the estimated local biometric sample to create a local hash output;
comparing the access control hash value to the local hash output; and
if the access control hash value is equal to the local hash output, allowing access to process of generating an encryption key or allowing access to a process of exchanging encrypted data.

65. (canceled)

66. (canceled)

67. The method of claim 51, further comprising:
receiving an encrypted message from the biometric security server;
generating an encryption key using the estimated local biometric sample; and
decrypting the encrypted message using the encryption key.

68. (canceled)

69. A device comprising:
a receiver that receives, from a biometric security server, a secure sketch output, the secure sketch output derived from an enrollment biometric sample;
a biometric sampler that collects at least one local biometric sample from a user; and
a processor, communicatively coupled with the receiver and the biometric sampler, the processor configured to:
process the at least one local biometric sample by:
transforming the at least one local biometric sample to create a transformed biometric using a one way function,
decode the transformed biometric to resolve measurement differences with a measurement difference resolution decoder using the secure sketch output to create at least one decoded local biometric sample,
correct errors in the at least one decoded local biometric sample using an error correction code decoder to determine an amount of corrected errors and create an estimated local biometric sample, and
if the amount of corrected errors is less than a first pre-determined threshold confirm a positive match.

70. The device of claim 69, wherein the processor is further configured to:
responsive to confirming a positive match, generate an encryption key; and
responsive to confirming a positive match, allowing access to a process of exchanging encrypted data.

71. (canceled)

72. (canceled)

73. The device of claim 69, wherein the processor is further configured to:
set a possible match counter and an attempts counter;
if the amount of corrected errors is greater than the first pre-determined threshold, determine whether the amount of corrected errors is less than a second pre-determined threshold; and
if the amount of corrected errors is less than a second pre-determined threshold:
increment the possible match counter; and
determine whether the possible match counter is greater than a third pre-determined threshold; and
if the possible match counter is greater than the third pre-determined threshold confirm a positive match.

74. The device of claim 73, wherein the processor is further configured to:
responsive to confirming a positive match, generating an encryption key; and
responsive to confirming a positive match, allowing access to a process of exchanging encrypted data.

75. (canceled)

76. (canceled)

77. (canceled)

78. (canceled)

79. (canceled)

80. (canceled)

81. (canceled)

82. The device of claim 69, wherein:
the receiver further receives, from the biometric security server, an access control hash value; and
the processor is further configured to:
perform a hash function on the estimated local biometric sample to create a local hash output,
compare the access control hash value to the local hash output, and
if the access control hash value is equal to the local hash output, allow access to a process of generating an encryption key or allow access to a process of exchanging encrypted data.

83. (canceled)

84. (canceled)

85. The device of claim 69, wherein:
the receiver further receives an encrypted message from the biometric security server; and
the processor is further configured to:
generate an encryption key using the estimated local biometric sample, and decrypt the encrypted message using the encryption key.

86. (canceled)
